(19) United States
(12) Patent Application Publication
(10) Pub. No.: US 2021/0066687 A1
(43) Pub. Date: Mar. 4, 2021

(54) ELECTROCHEMICAL CELLS HAVING HIGH-ASPECT-RATIO ELECTRODES

(71) Applicant: GM GLOBAL TECHNOLOGY OPERATIONS LLC, Detroit, MI (US)

(72) Inventors: Xiaochao QUE, Shanghai (CN); Meiyuan WU, Shanghai (CN); Haijing LIU, Shanghai (CN); Sherman H. ZENG, Troy, MI (US)

(73) Assignee: GM GLOBAL TECHNOLOGY OPERATIONS LLC, Detroit, MI (US)

(21) Appl. No.: 16/661,380

(22) Filed: Oct. 23, 2019

(30) Foreign Application Priority Data
Sep. 4, 2019 (CN) 201910830928.5

(51) Int. Cl. H01M 2/10; H01M 10/0525; H01M 2/30; H01M 4/04; H01M 4/66

(52) U.S. Cl. CPC H01M 2/1083; H01M 10/0525; H01M 2/305; H01M 2004/027; H01M 4/667; H01M 2220/20; H01M 4/0404

(57) ABSTRACT

An electrode component according to various aspects of the present disclosure includes an electrically-conductive layer and an electrode layer. The electrically-conductive layer includes a current collector portion and a tab portion. The electrode layer is disposed on at least a portion of the current collector portion. The electrode layer includes a first edge. The electrode layer includes an electroactive material. The electrode layer defines a first dimension substantially parallel to the first edge and a second dimension substantially perpendicular to the first edge. An aspect ratio of the first dimension to the second dimension is greater than or equal to about 2. The tab portion is disposed adjacent to at least a portion of the first edge. An interface between the electrode layer and the tab portion defines an interface length of greater than or equal to about 50% of the first dimension.

### CROSS-REFERENCE TO RELATED APPLICATIONS

This application claims the benefit and priority of Chinese Patent Application No. 201910830928.5, filed Sep. 4, 2019. The entire disclosure of the above application is incorporated herein by reference.

### INTRODUCTION

This section provides background information related to the present disclosure which is not necessarily prior art.

The present disclosure relates to electrodes having a high aspect ratio, electrochemical cells including high-aspect-ratio electrodes, and methods of making the electrodes and electrochemical cells.

High-energy-density electrochemical cells, such as lithium-ion batteries can be used in a variety of consumer products and vehicles, such as hybrid or electric vehicles. Battery powered vehicles show promise as a transportation option as technical advances continue to be made in battery power, lifetimes, and cost. One factor potentially limiting wider acceptance and use of battery-powered vehicles is the potentially limited driving range, especially in the earlier stages of adoption where charging stations are not yet ubiquitous as gas stations are today. It would be desirable to provide batteries capable of providing longer drive ranges and shorter charge times. In addition, battery-powered vehicles often are required to operate in extreme weather conditions, for example, at low temperatures in northern winter weather.

### SUMMARY

This section provides a general summary of the disclosure, and is not a comprehensive disclosure of its full scope or all of its features.

In various aspects, the present disclosure provides an electrode component including an electrically-conductive layer and an electrode layer. The electrically-conductive layer includes a current collector portion and a tab portion. The electrode layer is disposed on at least a portion of the current collector portion. The electrode layer includes a first edge. The electrode layer includes an electroactive material. The electrode layer defines a first dimension substantially parallel to the first edge and a second dimension substantially perpendicular to the first edge. An aspect ratio of the first dimension to the second dimension is greater than or equal to about 2. The tab portion is disposed adjacent to at least a portion of the first edge. An interface between the electrode layer and the tab portion defines an interface length of greater than or equal to about 50% of the first dimension.

In one aspect, the tab portion is disposed adjacent to substantially the entire first edge.

In one aspect, the tab portion is disposed adjacent to the first edge and the second edge. The tab portion extends continuously along the first edge and at least a portion of a second edge substantially perpendicular to the first edge.

In one aspect, the electrode component further includes a distinct tab component electrically connected to the tab portion. The tab component is electrically conductive.

In one aspect, the tab component is L-shaped. The tab component disposed adjacent to substantially the entire first edge.

In one aspect, the tab component is coupled to the tab portion by a plurality of welds. Each weld has an area of greater than or equal to about 30 mm² to less than or equal to about 10,000 mm².

In one aspect, the tab component includes an internal portion and a terminal portion. The internal portion is configured to be disposed inside of a battery housing. The terminal portion is configured to be disposed outside of a battery housing. The terminal portion defines a surface area of greater than or equal to about 600 mm² to less than or equal to about 20,000 mm².

In one aspect, the aspect ratio is greater than or equal to about 5.

In one aspect, the first dimension is greater than or equal to about 300 mm. The second dimension is less than or equal to about 150 mm.

In various aspects, the present disclosure provides an electrically-conductive component and an electrode layer. The electrically-conductive layer includes a current collector portion and a tab portion. The tab portion defines a first perimeter. The electrode layer is disposed on at least a portion of the current collector portion. The electrode layer includes an electroactive material. The electrode layer defines a second perimeter. The electrode layer defines a first dimension and a second dimension substantially perpendicular to the first dimension. An aspect ratio of the first dimension to the second dimension is greater than or equal to about 2. The second perimeter defines a concave polygon that shares at least two edges with the first perimeter.

In one aspect, the electrode layer includes a first axis and a second axis. The first axis extends substantially parallel to the first dimension and through a midpoint of the second dimension. The second axis extends substantially parallel to the second dimension and through a midpoint of the first dimension. The electrode layer includes a notch disposed along a concave portion of the second perimeter.

In one aspect, the electrode layer has (i) reflective symmetry about the first axis, (ii) reflective symmetry about the second axis, or (iii) second order rotational symmetry.

In one aspect, the second perimeter includes the at least two edges, a distinct first edge, and a distinct second edge. The first perimeter includes the at least two edges, a distinct third edge extending substantially collinear with the first edge, and a distinct fourth edge extending substantially collinear with the second edge.

In various aspects, the present disclosure provides an electrochemical device. The electrochemical device includes an electrochemical cell. The electrochemical cell includes a negative electrode component, a positive electrode component, and an electrolyte-separator system. The negative electrode component includes a first electrically-conductive layer and a negative electrode layer. The first electrically-conductive layer includes a first current collector portion and a first tab portion. The negative electrode layer is disposed on at least a portion of the first current collector portion. The negative electrode layer includes a first edge. The negative electrode layer includes a negative electroactive material. The negative electrode layer defines a first dimension substantially parallel to the first edge and a second dimension substantially perpendicular to the first edge. A first aspect ratio of the first dimension to the second dimension is greater than or equal to about 2. The first tab portion is disposed adjacent to at least a portion of the first edge. A first interface between the negative electrode layer and the first tab portion defines a first interface length of greater than or equal to about 50% of the first dimension. The positive electrode component includes a second electrically-conductive layer and a positive electrode layer. The second electrically-conductive layer includes a second current collector portion and a second tab portion. The positive electrode layer is disposed on at least a portion of the second current collector portion. The positive electrode layer includes a second edge. The positive electrode layer includes a positive electroactive material. The positive electrode layer defines a third dimension substantially parallel to the second edge and a fourth dimension substantially perpendicular to the second edge. A second aspect ratio of the third dimension to the fourth dimension is greater than or equal to about 2. The second tab portion is disposed adjacent to at least a portion of the second edge. A second interface between the positive electrode layer and the second tab portion defines a second interface length of greater than or equal to about 50% of the first dimension. The electrolyte-separator system is disposed between the positive electrode layer and the negative electrode layer. The electrode-separator system is ionically conductive and electrically insulating.

In one aspect, the negative electrode component further includes a first distinct tab component electrically connected to the first tab portion. The first tab component includes a first terminal portion configured to be disposed outside of a housing of the electrochemical device. The positive electrode component further includes a second distinct tab component electrically connected to the second tab portion. The second tab component includes a second terminal portion configured to be disposed outside of the housing. The first terminal portion and the second terminal portion are disposed on a common side of the electrochemical device.

In one aspect, the first terminal portion and the second terminal portion each have surface areas of greater than or equal to about 600 mm² to less than or equal to about 20,000 mm².

In one aspect, the first electrically-conductive layer includes a first electrically-conductive material selected from the group consisting of aluminum, copper, stainless steel, or combinations thereof. The second electrically-conductive layer includes a second electrically-conductive material selected from the group consisting of aluminum, stainless steel, or a combination thereof. The first tab component includes a third electrically-conductive material selected from the group consisting of nickel, copper, aluminum, or combinations thereof. The second tab component includes a fourth electrically-conductive material including aluminum.

In one aspect, the electrochemical cell includes a first electrochemical cell and a second electrochemical cell. The first electrochemical cell is electrically connected to the second electrochemical cell by a plurality of welds.

In one aspect, each weld of the plurality of welds has an area of greater than or equal to about 30 mm² to less than or equal to about 10,000 mm².

In one aspect, the negative electrode layer includes the negative electroactive material in an amount greater than or equal to about 80 weight percent to less than or equal to about 98 weight percent, a first binder in an amount greater than or equal to about 0.5 weight percent to less than or equal to about 10 weight percent, and a first conductive additive in an amount greater than or equal to about 0.5 weight percent to less than or equal to about 10 weight percent. The positive electrode layer includes the positive electroactive material in an amount greater than or equal to about 80 weight percent to less than or equal to about 98 weight percent, a second binder in an amount greater than or equal to about 0.5 weight percent to less than or equal to about 10 weight percent, and a second conductive additive in an amount greater than or equal to about 0.5 weight percent to less than or equal to about 10 weight percent.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view of an exemplary electrochemical cell according to various aspects of the present disclosure;

FIG. 2 is a side view of another exemplary electrochemical cell according to various aspects of the present disclosure;

FIGS. 3A-3G relate to an electrochemical device according to various aspects of the present disclosure; FIG. 3A is a side view of the electrochemical device; FIG. 3B is an exploded view of a plurality of electrochemical cells of the electrochemical device of FIG. 3A; FIG. 3C is a side view of a negative electrode component of the electrochemical device of FIG. 3A; FIG. 3D is a side view of a first electrically-conductive layer of the negative electrode component of FIG. 3C; FIG. 3E is a side view of a positive electrode component of the electrochemical device of FIG. 3A; FIG. 3F is a side view of a second electrically-conductive layer of the positive electrode component of FIG. 3E; and FIG. 3G is a side view of an electrochemical cell assembly of the electrochemical device of FIG. 3A;

FIGS. 4A-4B relate to another electrochemical device according to various aspects of the present disclosure; FIG. 4A is a side view of the electrochemical device; and FIG. 4B is a side view of an electrochemical cell assembly of the electrochemical device of FIG. 4A;

FIGS. 5A-5F relate to yet another electrochemical device according to various aspects of the present disclosure; FIG. 5A is a side view of the electrochemical device; FIG. 5B is a side view of a negative current collector foil of the electrochemical device of FIG. 5A; FIG. 5C is a side view of a first electrically-conductive layer of the negative electrode component of FIG. 5B; FIG. 5D is a positive electrode component of the electrochemical device of FIG. 5A; FIG. 5E is a side view of a second electrically-conductive layer of the positive electrode component of FIG. 5D; and FIG. 5F is an electrochemical cell assembly of the electrochemical device of FIG. 5A;

FIGS. 6A-6F relate to yet another electrochemical device according to various aspects of the present disclosure; FIG. 6A is a side view of the electrochemical device; FIG. 6B is a side view of a negative current collector foil of the electrochemical device of FIG. 6A; FIG. 6C is a side view of a first electrically-conductive layer of the negative electrode component of FIG. 6B; FIG. 6D is a positive electrode component of the electrochemical device of FIG. 6A; FIG. 6E is a side view of a second electrically-conductive layer of the positive electrode component of FIG. 6D; and FIG. 6F is an electrochemical cell assembly of the electrochemical device of FIG. 6A;

FIGS. 7A-7F relate to yet another electrochemical device according to various aspects of the present disclosure; FIG. 7A is a side view of the electrochemical device; FIG. 7B is a side view of a negative current collector foil of the electrochemical device of FIG. 7A; FIG. 7C is a side view of a first electrically-conductive layer of the negative electrode component of FIG. 7B; FIG. 7D is a positive electrode component of the electrochemical device of FIG. 7A; FIG. 7E is a side view of a second electrically-conductive layer of the positive electrode component of FIG. 7D; and FIG. 7F is an electrochemical cell assembly of the electrochemical device of FIG. 7A;

FIGS. 8A-8F relate to yet another electrochemical device according to various aspects of the present disclosure; FIG. 8A is a side view of the electrochemical device; FIG. 8B is a side view of a negative current collector foil of the electrochemical device of FIG. 8A; FIG. 8C is a side view of a first electrically-conductive layer of the negative electrode component of FIG. 8B; FIG. 8D is a positive electrode component of the electrochemical device of FIG. 8A; FIG. 8E is a side view of a second electrically-conductive layer of the positive electrode component of FIG. 8D; and FIG. 8F is an electrochemical cell assembly of the electrochemical device of FIG. 8A;

FIGS. 9A-9F relate to yet another electrochemical device according to various aspects of the present disclosure; FIG. 9A is a side view of the electrochemical device; FIG. 9B is a side view of a negative current collector foil of the electrochemical device of FIG. 9A; FIG. 9C is a side view of a first electrically-conductive layer of the negative electrode component of FIG. 9B; FIG. 9D is a positive electrode component of the electrochemical device of FIG. 9A; FIG. 9E is a side view of a second electrically-conductive layer of the positive electrode component of FIG. 9D; and FIG. 9F is an electrochemical cell assembly of the electrochemical device of FIG. 9A;

FIG. 10 is a flowchart depicting a method of manufacturing an electrochemical device according to various aspects of the present disclosure;

FIG. 11 is a schematic view of an electrode component precursor for the negative electrode component of FIG. 3C according to various aspect of the present disclosure;

FIG. 12 is a schematic view of another electrode component precursor for the negative electrode component of FIG. 5B according to various aspects of the present disclosure; and

FIG. 13 is a schematic view of yet another electrode component precursor for the negative electrode component of FIG. 9B according to various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present technology pertains to rechargeable lithium-ion batteries, which may be used in vehicle applications. However, the present technology may also be used in other electrochemical devices that cycle lithium ions, such as handheld electronic devices. A rechargeable lithium-ion battery is provided that may exhibit high energy density, low capacity fade, and high Coulombic efficiency.

### General Electrochemical Cell Function, Structure, and Composition

A typical electrochemical cell includes a first electrode, such as a positive electrode or cathode, a second electrode such as a negative electrode or an anode, an electrolyte, and a separator. Often, in a lithium-ion battery pack, electrochemical cells are electrically connected in a stack to increase overall output. Lithium-ion electrochemical cells operate by reversibly passing lithium ions between the negative electrode and the positive electrode. The separator and the electrolyte are disposed between the negative and positive electrodes. The electrolyte is suitable for conducting lithium ions and may be in liquid, gel, or solid form. Lithium ions move from a positive electrode to a negative electrode during charging of the battery, and in the opposite direction when discharging the battery.

Each of the negative and positive electrodes within a stack is typically electrically connected to a current collector (e.g., a metal, such as copper for the negative electrode and aluminum for the positive electrode). During battery usage, the current collectors associated with the two electrodes are connected by an external circuit that allows current generated by electrons to pass between the negative and positive electrodes to compensate for transport of lithium ions.

Electrodes can generally be incorporated into various commercial battery designs, such as prismatic shaped cells, wound cylindrical cells, coin cells, pouch cells, or other suitable cell shapes. The cells can include a single electrode structure of each polarity or a stacked structure with a plurality of positive electrodes and negative electrodes assembled in parallel and/or series electrical connections. In particular, the battery can include a stack of alternating positive electrodes and negative electrodes with separators disposed therebetween. While the positive electroactive materials can be used in batteries for primary or single charge use, the resulting batteries generally have desirable cycling properties for secondary battery use over multiple cycling of the cells.

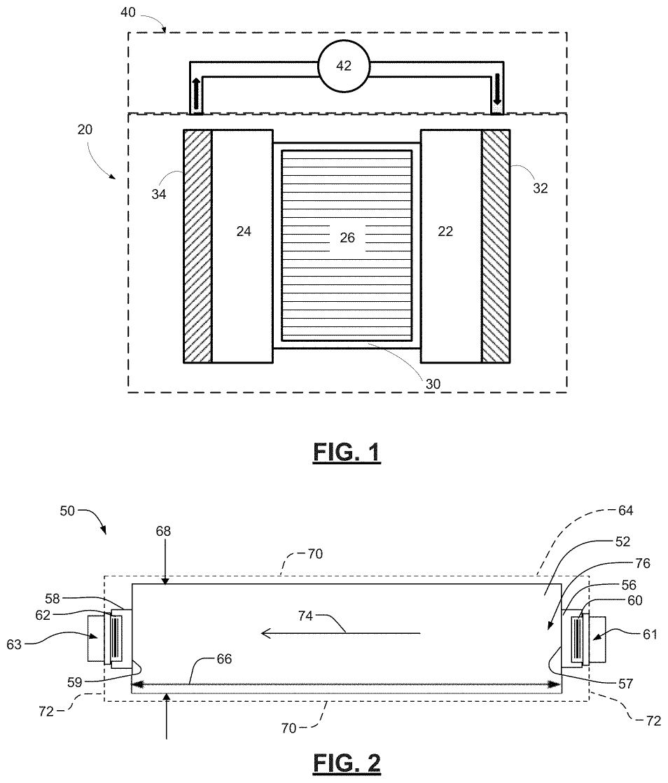

An exemplary schematic illustration of a lithium-ion battery 20 is shown in FIG. 1. The lithium-ion battery 20 includes a negative electrode 22, a positive electrode 24, and a porous separator 26 (e.g., a microporous or nanoporous polymeric separator) disposed between the negative and positive electrodes 22, 24. An electrolyte 30 is disposed between the negative and positive electrodes 22, 24 and in pores of the porous separator 26. The electrolyte 30 may also be present in the negative electrode 22 and positive electrode 24, such as in pores.

A negative electrode current collector 32 may be positioned at or near the negative electrode 22. A positive electrode current collector 34 may be positioned at or near the positive electrode 24. While not shown, the negative electrode current collector 32 and the positive electrode current collector 34 may be coated on one or both sides, as is known in the art. In certain aspects, the current collectors may be coated with an electroactive material/electrode layer on both sides. The negative electrode current collector 32 and positive electrode current collector 34 respectively collect and move free electrons to and from an external circuit 40. The interruptible external circuit 40 includes a load device 42 connects the negative electrode 22 (through the negative electrode current collector 32) and the positive electrode 24 (through the positive electrode current collector 34).

The porous separator 26 operates as both an electrical insulator and a mechanical support. More particularly, the porous separator 26 is disposed between the negative electrode 22 and the positive electrode 24 to prevent or reduce physical contact and thus, the occurrence of a short circuit. The porous separator 26, in addition to providing a physical barrier between the two electrodes 22, 24, can provide a minimal resistance path for internal passage of lithium ions (and related anions) during cycling of the lithium ions to facilitate functioning of the lithium-ion battery 20.

The lithium-ion battery 20 can generate an electric current during discharge by way of reversible electrochemical reactions that occur when the external circuit 40 is closed (to electrically connect the negative electrode 22 and the positive electrode 24) when the negative electrode 22 contains a relatively greater quantity of cyclable lithium. The chemical potential difference between the positive electrode 24 and the negative electrode 22 drives electrons produced by the oxidation of lithium (e.g., intercalated/alloyed/plated lithium) at the negative electrode 22 through the external circuit 40 toward the positive electrode 24. Lithium ions, which are also produced at the negative electrode, are concurrently transferred through the electrolyte 30 and porous separator 26 towards the positive electrode 24. The electrons flow through the external circuit 40 and the lithium ions migrate across the porous separator 26 in the electrolyte 30 to intercalate/alloy/plate into a positive electroactive material of the positive electrode 24. The electric current passing through the external circuit 40 can be harnessed and directed through the load device 42 until the lithium ions in the negative electrode 22 are depleted and the capacity of the lithium-ion battery 20 is diminished.

The lithium-ion battery 20 can be charged or re-energized at any time by connecting an external power source (e.g., charging device) to the lithium-ion battery 20 to reverse the electrochemical reactions that occur during battery discharge. The connection of an external power source to the lithium-ion battery 20 compels the lithium ions at the positive electrode 24 to move back toward the negative electrode 22. The electrons, which flow back towards the negative electrode 22 through the external circuit 40, and the lithium ions, which are carried by the electrolyte 30 across the separator 26 back towards the negative electrode 22, reunite at the negative electrode 22 and replenish it with lithium for consumption during the next battery discharge cycle. As such, each discharge and charge event is considered to be a cycle, where lithium ions are cycled between the positive electrode 24 and negative electrode 22.

The external power source that may be used to charge the lithium-ion battery 20 may vary depending on the size, construction, and particular end-use of the lithium-ion battery 20. Some notable and exemplary external power sources include, but are not limited to, AC power sources, such as an AC wall outlet or a motor vehicle alternator. A converter may be used to change from AC to DC for charging the battery 20.

In many lithium-ion battery configurations, each of the negative electrode current collector 32, negative electrode 22, the separator 26, positive electrode 24, and positive electrode current collector 34 are prepared as relatively thin layers (for example, from several microns to a millimeter or less in thickness) and assembled in layers connected in electrical series and/or parallel arrangement to provide a suitable electrical energy and power package. Furthermore, the lithium-ion battery 20 can include a variety of other components that, while not depicted here, are nonetheless known to those of skill in the art. For instance, the lithium-ion battery 20 may include a casing, gaskets, terminal caps, tabs, battery terminals, and any other conventional components or materials that may be situated within the battery 20, including between or around the negative electrode 22, the positive electrode 24, and/or the separator 26, by way of non-limiting example. As noted above, the size and shape of the lithium-ion battery 20 may vary depending on the particular application for which it is designed. Battery-powered vehicles and handheld consumer electronic devices are two examples where the lithium-ion battery 20 would most likely be designed to different size, capacity, and power-output specifications. The lithium-ion battery 20 may also be connected in series or parallel with other similar lithium-ion cells or batteries to produce a greater voltage output, energy, and/or power as required by the load device 42.

Accordingly, the lithium-ion battery 20 can generate electric current to a load device 42 that can be operatively connected to the external circuit 40. While the load device 42 may be any number of known electrically-powered devices, a few specific examples of power-consuming load devices include an electric motor for a hybrid vehicle or an all-electric vehicle, a laptop computer, a tablet computer, a cellular phone, and cordless power tools or appliances, by way of non-limiting example. The load device 42 may also be a power-generating apparatus that charges the lithium-ion battery 20 for purposes of storing energy. In certain other variations, the electrochemical cell may be a supercapacitor, such as a lithium-ion based supercapacitor.

### Electrolyte

Any appropriate electrolyte 30, whether in solid, liquid, or gel form, capable of conducting lithium ions between the negative electrode 22 and the positive electrode 24 may be used in the lithium-ion battery 20. In certain aspects, the electrolyte 30 may be a non-aqueous liquid electrolyte solution that includes a lithium salt dissolved in an organic solvent or a mixture of organic solvents. Numerous conventional non-aqueous liquid electrolyte 30 solutions may be employed in the lithium-ion battery 20. In certain variations, the electrolyte 30 may include an aqueous solvent (i.e., a water-based solvent) or a hybrid solvent (e.g., an organic solvent including at least 1% water by weight).

Appropriate lithium salts generally have inert anions. Non-limiting examples of lithium salts that may be dissolved in an organic solvent to form the non-aqueous liquid electrolyte solution include lithium hexafluorophosphate (LiPF₆); lithium perchlorate (LiClO₄); lithium tetrachloroaluminate (LiAlCl₄); lithium iodide (LiI); lithium bromide (LiBr); lithium thiocyanate (LiSCN); lithium tetrafluoroborate (LiBF₄); lithium difluorooxalatoborate (LiBF₂(C₂O₄)) (LiODFB), lithium tetraphenylborate (LiB(C₆H₅)₄); lithium bis-(oxalate)borate (LiB(C₂O₄)₂) (LiBOB); lithium tetrafluorooxalatophosphate (LiPF₄(C₂O₄)) (LiFOP), lithium nitrate (LiNO₃), lithium hexafluoroarsenate (LiAsF₆); lithium trifluoromethanesulfonate (LiCF₃SO₃); lithium bis(trifluoromethanesulfonimide) (LITFSI) (LiN(CF₃SO₂)₂); lithium fluorosulfonylimide (LiN(FSO₂)₂) (LIFSI); and combinations thereof. In certain variations, the electrolyte 30 may include a 1 M concentration of the lithium salts.

These lithium salts may be dissolved in a variety of organic solvents, such as organic ethers or organic carbonates, by way of example. Organic ethers may include dimethyl ether, glyme (glycol dimethyl ether or dimethoxyethane (DME, e.g., 1,2-dimethoxyethane)), diglyme (diethylene glycol dimethyl ether or bis(2-methoxyethyl) ether), triglyme (tri(ethylene glycol) dimethyl ether), additional chain structure ethers, such as 1-2-diethoxyethane, ethoxymethoxyethane, 1,3-dimethoxypropane (DMP), cyclic ethers, such as tetrahydrofuran, 2-methyltetrahydrofuran, and combinations thereof. In certain variations, the organic ether compound is selected from the group consisting of: tetrahydrofuran, 2-methyl tetrahydrofuran, dioxolane, dimethoxy ethane (DME), diglyme (diethylene glycol dimethyl ether), triglyme (tri(ethylene glycol) dimethyl ether), 1,3-dimethoxypropane (DMP), and combinations thereof. Carbonate-based solvents may include various alkyl carbonates, such as cyclic carbonates (e.g., ethylene carbonate, propylene carbonate, butylene carbonate) and acyclic carbonates (e.g., dimethyl carbonate, diethyl carbonate, ethyl methyl carbonate (EMC)). Ether-based solvents include cyclic ethers (e.g., tetrahydrofuran, 2-methyltetrahydrofuran, 1,3-dioxolane) and chain structure ethers (e.g., 1,2-dimethoxyethane, 1-2-diethoxyethane, ethoxymethoxyethane).

In various embodiments, appropriate solvents in addition to those described above may be selected from propylene carbonate, dimethyl carbonate, diethyl carbonate, methyl ethyl carbonate, γ-butyrolactone, dimethyl sulfoxide, acetonitrile, nitromethane and mixtures thereof.

Where the electrolyte is a solid state electrolyte, it may include a composition selected from the group consisting of: LiTi₂(PO4)₃, Li_{1.3}Al_{0.3}Ti_{1.7}(PO₄)₃ (LATP), LiGe₂(PO₄)₃, Li₇La₃Zr₂O₁₂, Li₃xLa_{2/3}-xTiO₃, Li₃PO₄, Li₃N, Li₄GeS₄, Li₁₀GeP₂S₁₂, Li₂S—P₂S₅, Li₆PS₅Cl, Li₆PS₅Br, Li₆PS₅I, Li₃OCl, Li_{2.99}Ba_{0.005}ClO, or any combination thereof.

### Porous Separator

The porous separator 26 may include, in certain variations, a microporous polymeric separator including a polyolefin, including those made from a homopolymer (derived from a single monomer constituent) or a heteropolymer (derived from more than one monomer constituent), which may be either linear or branched. In certain aspects, the polyolefin may be polyethylene (PE), polypropylene (PP), or a blend of PE and PP, or multi-layered structured porous films of PE and/or PP. Commercially available polyolefin porous separator 26 membranes include CELGARD® 2500 (a monolayer polypropylene separator) and CELGARD® 2340 (a trilayer polypropylene/polyethylene/polypropylene separator) available from Celgard LLC.

When the porous separator 26 is a microporous polymeric separator, it may be a single layer or a multi-layer laminate. For example, in one embodiment, a single layer of the polyolefin may form the entire microporous polymer separator 26. In other aspects, the separator 26 may be a fibrous membrane having an abundance of pores extending between the opposing surfaces and may have a thickness of less than a millimeter, for example. As another example, however, multiple discrete layers of similar or dissimilar polyolefins may be assembled to form the microporous polymer separator 26. The microporous polymer separator 26 may also include other polymers alternatively or in addition to the polyolefin such as, but not limited to, polyethylene terephthalate (PET), polyvinylidene fluoride (PVdF), polyamide (nylons), polyurethanes, polycarbonates, polyesters, polyetheretherketones (PEEK), polyethersulfones (PES), polyimides (PI), polyamide-imides, polyethers, polyoxymethylene (e.g., acetal), polybutylene terephthalate, polyethylenenaphthenate, polybutene, polymethylpentene, polyolefin copolymers, acrylonitrile-butadiene styrene copolymers (ABS), polystyrene copolymers, polymethylmethacrylate (PMMA), polysiloxane polymers (e.g., polydimethylsiloxane (PDMS)), polybenzimidazole (PBI), polybenzoxazole (PBO), polyphenylenes, polyarylene ether ketones, polyperfluorocyclobutanes, polyvinylidene fluoride copolymers (e.g., PVdF-hexafluoropropylene or (PVdF-HFP)), and polyvinylidene fluoride terpolymers, polyvinylfluoride, liquid crystalline polymers (e.g., VECTRAN™ (Hoechst AG, Germany) and ZENITE® (DuPont, Wilmington, Del.)), polyaramides, polyphenylene oxide, cellulosic materials, meso-porous silica, or a combination thereof.

Furthermore, the porous separator 26 may be mixed with a ceramic material or its surface may be coated in a ceramic material. For example, a ceramic coating may include alumina (Al₂O₃), silicon dioxide (SiO₂), or combinations thereof. Various conventionally available polymers and commercial products for forming the separator 26 are contemplated, as well as the many manufacturing methods that may be employed to produce such a microporous polymer separator 26.

### Solid-State Electrolyte

In various aspects, the porous separator 26 and the electrolyte 30 may be replaced with a solid state electrolyte (SSE) that functions as both an electrolyte and a separator. The SSE may be disposed between a positive electrode and a negative electrode. The SSE facilitates transfer of lithium ions, while mechanically separating and providing electrical insulation between the negative and positive electrodes 22, 24. By way of non-limiting example, SSEs may include LiTi₂(PO₄)₃, Li_{1.3}Al_{0.3}Ti_{1.7}(PO₄)₃ (LATP), LiGe₂(PO₄)₃, Li₇La₃Zr₂O₁₂, Li₃xLa_{2/3}-xTiO₃, Li₃PO₄, Li₃N, Li₄GeS₄, Li₁₀GeP₂S₁₂, Li₂S—P₂S₅, Li₆PS₅Cl, Li₆PS₅Br, Li₆PS₅I, Li₃OCl, Li_{2.99} Ba_{0.005}ClO, or combinations thereof.

### Positive Electrode

The positive electrode 24 may be formed from or include a lithium-based active material that can undergo lithium intercalation and deintercalation, alloying and dealloying, or plating and stripping, while functioning as the positive terminal of the lithium-ion battery 20. The positive electrode 24 may include a positive electroactive material. Positive electroactive materials may include one or more transition metals cations, such as manganese (Mn), nickel (Ni), cobalt (Co), chromium (Cr), iron (Fe), vanadium (V), and combinations thereof. However, in certain variations, the positive electrode 24 is substantially free of select metal cations, such as nickel (Ni) and cobalt (Co).

Two exemplary common classes of known electroactive materials that can be used to form the positive electrode 24 are lithium transition metal oxides with layered structures and lithium transition metal oxides with spinel phase. For example, in certain instances, the positive electrode 24 may include a spinel-type transition metal oxide, like lithium manganese oxide (Li₍₁₊ₓ₎Mn₍₂₋ₓ₎O₄), where x is typically <0.15, including LiMn₂O₄ (LMO) and lithium manganese nickel oxide LiMn_{1.5}Ni_{0.5}O₄ (LMNO). In other instances, the positive electrode 24 may include layered materials like lithium cobalt oxide (LiCoO₂), lithium nickel oxide (LiNiO₂), a lithium nickel manganese cobalt oxide (Li(NiₓMn_{y}Co_{z})O₂), where 0≤x≤1, 0≤y≤1, 0≤z≤1, and x+y+z=1 (e.g., LiNi_{0.6}Mn_{0.2}Co_{0.2}O₂, LiNi_{0.8}Mn_{0.1}Co_{0.1}O₂, and/or LiMn_{0.33}Ni_{0.33}Co_{0.33}O₂), a lithium nickel cobalt metal oxide (LiNi_{(1-x-y)}CoₓM_{y}O₂), where 0<x<1, 0<y<1 and M may be Al, Mn, or the like. Other known lithium-transition metal compounds such as lithium iron phosphate (LiFePO₄) or lithium iron fluorophosphate (Li₂FePO₄F) can also be used. In certain aspects, the positive electrode 24 may include an electroactive material that includes manganese, such as lithium manganese oxide (Li₍₁₊ₓ₎Mn₍₂₋ₓ₎O₄), a mixed lithium manganese nickel oxide (LiMn₍₂₋ₓ₎NiₓO₄), where 0≤x≤1, and/or a lithium manganese nickel cobalt oxide (e.g., LiNi_{0.6}Mn_{0.2}Co_{0.2}O₂, LiNi_{0.8}Mn_{0.1}Co_{0.1}O₂, and/or LiMn_{0.33}Ni_{0.33}Co_{0.33}O₂). In a lithium-sulfur battery, positive electrodes may have elemental sulfur as the active material or a sulfur-containing active material.

The positive electroactive materials may be powder compositions. The positive electroactive materials may optionally be intermingled with an electrically-conductive additive material (e.g., electrically-conductive particles) and a polymeric binder. The binder may both hold together the positive electroactive material and provide ionic conductivity to the positive electrode 24. The polymeric binder may include polyvinylidene fluoride (PVdF), poly(vinylidene chloride) (PVC), poly((dichloro-1,4-phenylene)ethylene), carboxymethoxyl cellulose (CMC), nitrile butadiene rubber (NBR), fluorinated urethanes, fluorinated epoxides, fluorinated acrylics, copolymers of halogenated hydrocarbon polymers, epoxides, ethylene propylene diamine termonomer rubber (EPDM), hexafluoropropylene (HFP), ethylene acrylic acid copolymer (EAA), ethylene vinyl acetate copolymer (EVA), EAA/EVA copolymers, PVDF/HFP copolymers, polyvinylidene difluoride (PVdF), lithium polyacrylate (LiPAA), sodium polyacrylate (NaPAA), sodium alginate, lithium alginate, or a combination thereof.

Electrically-conductive additive materials may include graphite, other carbon-based materials, conductive metals, or conductive polymer particles. Carbon-based materials may include, by way of non-limiting example, particles of KETCHEN™ black, DENKA™ black, acetylene black, carbon black, and the like. Conductive metal particles may include nickel, gold, silver, copper, aluminum, and the like. Examples of a conductive polymer include polyaniline, polythiophene, polyacetylene, polypyrrole, and the like. In certain aspects, mixtures of electrically conductive materials may be used. While the supplemental electrically-conductive additive materials may be described as powders, these materials lose their powder character following incorporation into the electrode where the associated particles of the supplemental electrically conductive material become a component of the resulting electrode structure.

### Negative Electrode

The negative electrode 22 may include a negative electroactive material as a lithium host material capable of functioning as a negative terminal of the lithium-ion battery 20. Common negative electroactive materials include lithium insertion materials or alloy host materials. Such materials can include carbon-based materials, such as lithium-graphite intercalation compounds, lithium-silicon compounds, lithium-tin alloys, or lithium titanate Li₄₊ₓTi₅O₁₂, where 0≤x≤3, such as Li₄Ti₅O₁₂ (LTO).

In certain aspects, the negative electrode 22 may include lithium, and in certain variations metallic lithium and the lithium-ion battery 20. The negative electrode 22 may be a lithium metal electrode (LME). The lithium-ion battery 20 may be a lithium-metal battery or cell. Metallic lithium for use in the negative electrode of a rechargeable battery has various potential advantages, including having the highest theoretical capacity and lowest electrochemical potential. Thus, batteries incorporating lithium-metal anodes can have a higher energy density that can potentially double storage capacity, so that the battery may be half the size, but still last the same amount of time as other lithium-ion batteries.

In certain variations, the negative electrode 22 may optionally include an electrically-conductive additive material, as well as one or more polymeric binder materials to structurally hold the lithium material together. For example, in one embodiment, the negative electrode 22 may include an active material including lithium-metal particles intermingled with a binder material selected from the group consisting of: polyvinylidene difluoride (PVdF), ethylene propylene diene monomer (EPDM) rubber, carboxymethoxyl cellulose (CMC), a nitrile butadiene rubber (NBR), lithium polyacrylate (LiPAA), sodium polyacrylate (NaPAA), sodium alginate, lithium alginate, or a combination thereof. Suitable electrically-conductive additive materials may include carbon-based material or a conductive polymer. Carbon-based materials may include by way of example, particles of KETCHEN′ black, DENKA′ black, acetylene black, carbon black, and the like. Examples of a conductive polymer include polyaniline, polythiophene, polyacetylene, polypyrrole, and the like. In certain aspects, mixtures of electrically-conductive materials may be used.

### Electrode Fabrication

In various aspects, the negative and positive electrodes 22, 24 may be fabricated by mixing the respective electroactive material into a slurry with a polymeric binder compound, a non-aqueous solvent, optionally a plasticizer, and optionally if necessary, electrically conductive particles. The slurry can be mixed or agitated, and then thinly applied to a substrate via slot die coating. The substrate can be a removable substrate or alternatively a functional substrate, such as a current collector (such as a metallic grid or mesh layer) attached to one side of the electrode film. In one variation, heat or radiation can be applied to evaporate the solvent from the electrode film, leaving a solid residue. The electrode film may be further consolidated, where heat and pressure are applied to the film to sinter and calender it. In other variations, the film may be dried at moderate temperature to form self-supporting films. If the substrate is removable, then it is removed from the electrode film that is then further laminated to a current collector. With either type of substrate, the remaining plasticizer may be extracted prior to incorporation into the battery cell. In various aspects, a solid electrode may be formed according to alternative fabrication methods.

### Optional Electrode Surface Coatings

In certain variations, pre-fabricated negative electrodes 22 and positive electrodes 24 formed via the active material slurry casting described above can be directly coated via a vapor coating formation process to form a conformal inorganic-organic composite surface coating, as described further below. Thus, one or more exposed regions of the pre-fabricated negative electrodes including the electroactive material can be coated to minimize or prevent reaction of the electrode materials with components within the electrochemical cell to minimize or prevent lithium metal dendrite formation on the surfaces of negative electrode materials when incorporated into the electrochemical cell. In other variations, a plurality of particles including an electroactive material, like lithium metal, can be coated with an inorganic-organic composite surface coating. Then, the coated electroactive particles can be used in the active material slurry to form the negative electrode, as described above.

### Current Collectors

The negative and positive electrodes 22, 24 are generally associated with the respective negative and positive electrode current collectors 32, 34 to facilitate the flow of electrons between the electrode and the external circuit 40. The current collectors 32, 34 are electrically conductive and can include metal, such as a metal foil, a metal grid or screen, or expanded metal. Expanded metal current collectors refer to metal grids with a greater thickness such that a greater amount of electrode material is placed within the metal grid. By way of non-limiting example, electrically-conductive materials include copper, nickel, aluminum, stainless steel, titanium, alloys thereof, or combinations thereof.

The positive electrode current collector 34 may be formed from aluminum, stainless steel, or any other appropriate electrically conductive material known to those of skill in the art. The negative electrode current collector 32 may be formed from copper, aluminum, stainless steel, or any other appropriate electrically conductive material known to those of skill in the art.

### High-Aspect-Ratio Electrochemical Cells

With reference to FIG. 2, another electrochemical cell 50 according to various aspects of the present disclosure is provided. The electrochemical cell 50 includes a high-aspect ratio negative electrode 52 and a high-aspect-ratio positive electrode. Accordingly, the electrochemical cell 50 may be referred to as a high-aspect-ratio electrochemical cell.

The negative electrode 52 is coupled to a negative electrode current collector having a negative tab portion 56. The coupled negative electrode 52 and negative electrode current collector may be collectively referred to as a negative electrode component or a negative electrode foil. In certain aspects, an electrode component may include both an electrically-conductive portion and an electroactive material portion. A negative interface 57 is a boundary between the negative electrode 52 and the negative tab portion 56. The positive electrode is coupled to a positive electrode current collector having a positive tab portion 58. The coupled positive electrode and positive electrode current collector may be collectively referred to as a positive electrode component. A positive interface 59 is a boundary between the positive electrode and the positive tab portion 58.

The negative tab portion 56 is electrically connected to a distinct negative tab component 60. The negative tab component 60 includes a negative terminal portion 61. The positive tab portion 58 is electrically connected to a distinct positive tab component 62. The positive tab component 62 includes a positive terminal portion 63. The negative and positive terminal portions 61, 63 extend outside of an electrically-insulating housing or case 64 of the electrochemical cell 50 for connection to an external circuit (see, e.g., external circuit 40 of FIG. 1). The negative and positive tab portions components 56, 58 of the respective current collectors are disposed inside of the housing 64 and may therefore, in certain variations, be referred to as internal tabs.

The negative electrode 52 and the positive electrode have a first dimension or length 66 and a second dimension or width 68. The first dimension 66 is greater than the second dimension 68. For example, an aspect ratio of the first dimension 66 to the second dimension 68 may be greater than or equal to about 2, as will be described in greater detail below. The electrochemical cell 50 includes a pair of primary sides 70 extending substantially parallel to the first dimension 66 and a pair of secondary sides 72 extending substantially parallel to the second dimension 68.

The negative and positive tab portions 56, 58 are disposed on opposing secondary sides 72 of the electrochemical cell 50. Thus, during operation of the electrochemical cell 50, current generally flows across the entire first dimension 66 of the electrochemical cell 50. For example, during discharge, current may generally flow from the negative tab portion and terminal 56, 60 to the positive tab portion and terminal 58, 62 as indicated by arrow 74. Current may flow in the opposite direction during charge. The relatively long first dimension 66 and relatively short second dimension 68 may result in non-uniform current density, particularly during high current operation of the electrochemical cell 50.

Because substantially all of the current flows through the relatively-small positive tab portion 58, a localized high-current-density region 76 may be disposed near the positive terminal during discharge, for example. High current density can lead to thermal gradients and cause lithium plating, especially during high or low temperature operation and/or fast charge or discharge of the electrochemical cell 50.

### Electrochemical Devices Having High-Aspect-Ratio Electrodes, Improved Current Density, and Decreased Internal Resistance

In various aspects, the present disclosure provides electrochemical cells having high-aspect-ratio electrodes. The electrochemical cells generally include electrode and current collector geometries that facilitate uniform current flow and reduce or eliminate localized high-current-density regions. The electrochemical cells may be cycled with reduced or no lithium plating, particularly during high and low temperature cycling and/or fast-charge operation.

High-aspect-ratio electrodes may have a first electrode dimension or length that is greater than a second electrode dimension or width. When an electrode has a length and or width that are not constant, the aspect ratio may be determined based on maximum length and maximum width. In various aspects, an aspect ratio of the first dimension to the second dimension may be greater than or equal to about two, optionally greater than or equal to about 3, optionally greater than or equal to about 4, optionally greater than or equal to about 5, optionally greater than or equal to about 6, optionally greater than or equal to about 7, optionally greater than or equal to about 8, optionally greater than or equal to about 9, optionally greater than or equal to about 10, or optionally greater than or equal to about 15. By way of example, the aspect ratio may be greater than or equal to about 2 to less than or equal to about 20, optionally greater than or equal to about 2.5 to less than or equal to about 10, or optionally greater than or equal to about 5 to less than or equal to about 6. In certain aspects, the first dimension may be greater than or equal to about 300 mm and the second dimension may be less than or equal to about 150 mm.

In certain aspects, a high-aspect-ratio electrode may be coupled to and in electrical communication with an electrically-conductive layer to form an electrode component. For example, the electrode may be present as an electrode coating layer on one or both sides of an electrically-conductive layer. Each electrically-conductive layer includes a current collector portion and a tab portion. The current collector and tab portions may be integrally formed, for example, they may be different regions on an electrically-conductive foil. The electrode layer is coated or disposed on at least a portion of the current collector portion, such as substantially the entire current collector portion. The tab portion is substantially free of electrode material. The tab portion may be an internal tab portion such that it is disposed entirely within a housing. In certain aspects, the electrode component includes a distinct tab component, including a terminal, which is electrically connected to the internal tab portion. In various alternative aspects, the electrode component is free of a distinct tab component.

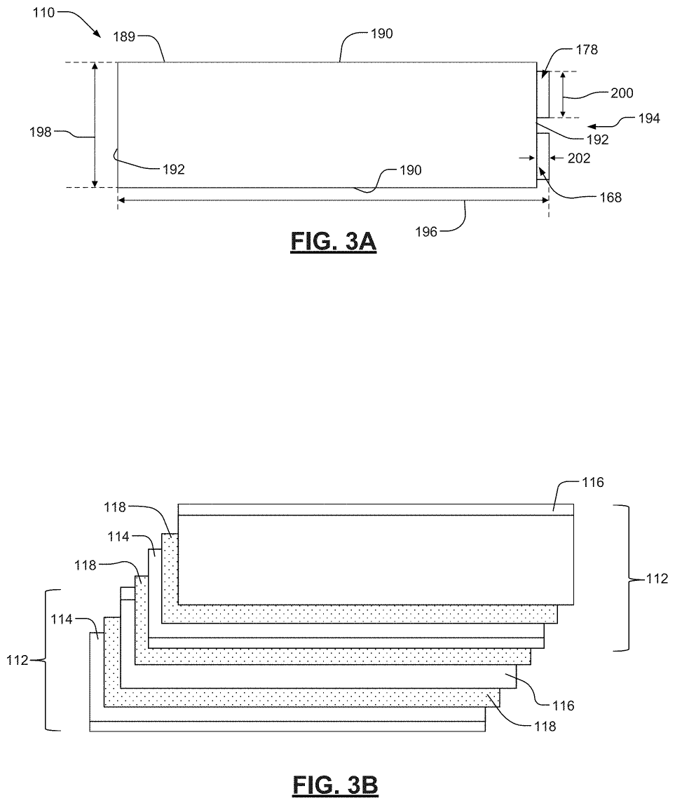

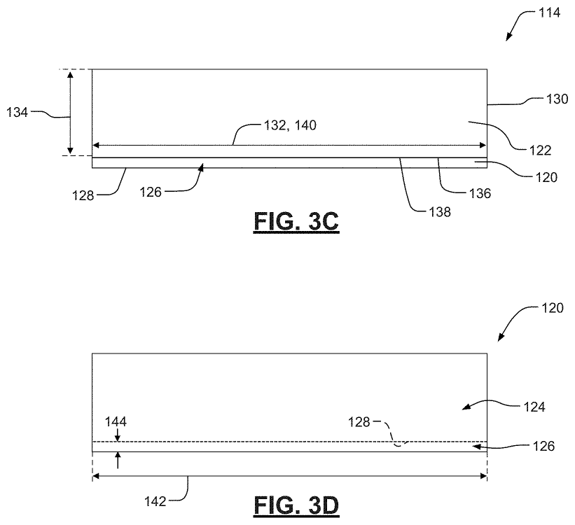

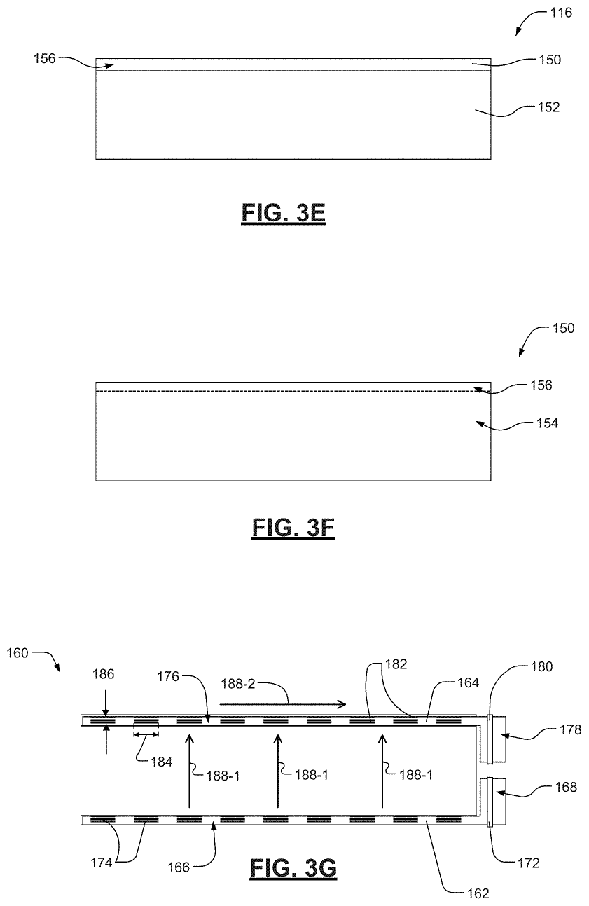

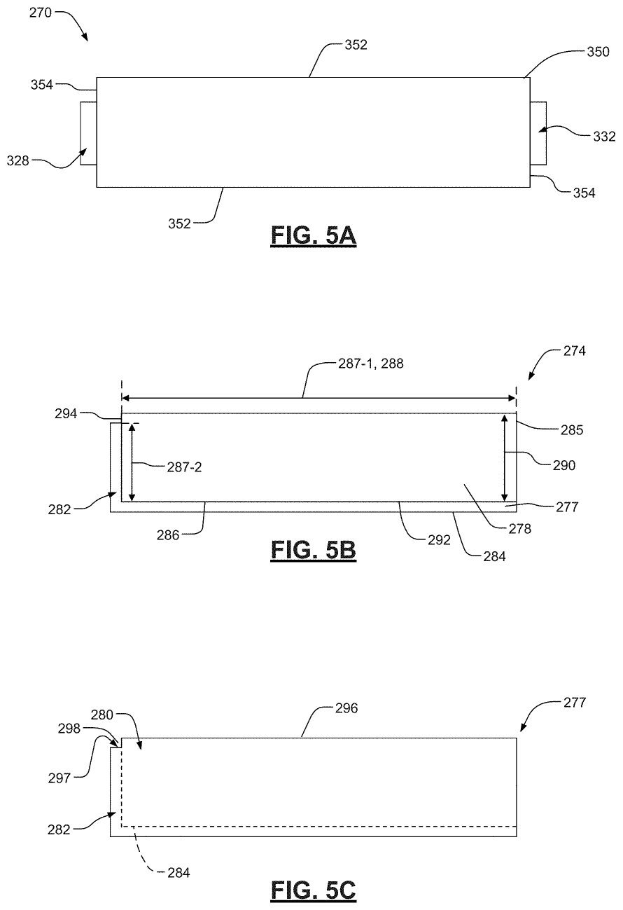

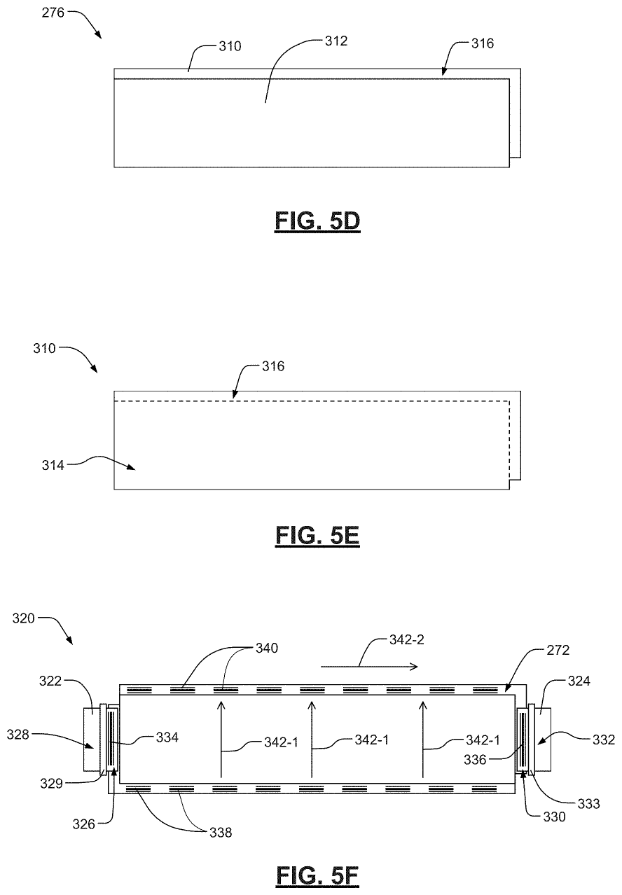

In various aspects, the high-aspect-ratio electrodes of the present disclosure may have tab designs that facilitate reductions in localized current density and improvements in current uniformity. Localized current density, particularly at the respective tabs, may be decreased by increasing respective interface lengths (see, e.g., negative and positive interfaces 57, 59 of FIG. 2) between the electrodes and tabs. In some embodiments, a tab is disposed along at least a portion of a long edge (see, e.g., primary sides 70 of FIG. 2) of a high-aspect-ratio electrode. An interface length between an electrode and tab may be greater than or equal to about 50% of the length of the electrode, as will be described in greater detail below (see, e.g., FIGS. 3C, 5B, 6B, 7B). In certain aspects, a tab comprises a first perimeter and an electrode comprises a second perimeter. The first and second perimeters may share at least two edges, as will be described in greater detail below (see, e.g., FIGS. 5B, 6B, 7B, 8B, 9B).

In various aspects, the present disclosure provides electrochemical devices including one or more electrochemical cells having high-aspect-ratio electrodes. The electrochemical cells can be arranged in stacking or winding configurations, by way of example. The electrochemical device may include equal quantities of negative electrodes and positive electrodes or one more negative electrode than positive electrode. In certain aspects, the electrochemical device may be a pouch battery or a prismatic metal can battery.

Electrochemical cells of the electrochemical device may be connected to one another in series and/or parallel. Electrochemical cells may be electrically connected to one another along respective internal tabs. In various aspects, the relatively large internal tabs provide space for an increased quantity of welds and/or increased weld sizes, thereby reducing a resistance between electrochemical cells in an electrochemical device having electrochemical cells with smaller internal tabs.

### Example Cell Layouts

### FIGS. 3A-3G

With reference to FIG. 3A, an electrochemical device 110 according to various aspects of the present disclosure is provided. As shown in FIG. 3B, the electrochemical device 110 includes one or more electrochemical cells 112. Each electrochemical cell 112 includes a negative electrode component 114, a positive electrode component 116, and an electrolyte-separator system 118. Adjacent electrochemical cells 112 are separated by electrolyte-separator systems 118. As will be discussed in greater detail below, the electrolyte-separator system 118 may include a polymeric separator and a liquid or gel electrolyte, or a solid-state electrolyte, by way of example.

Referring to FIGS. 3C-3D, the negative electrode component 114 includes a first electrically-conductive layer 120 and a negative electrode layer 122. The first electrically-conductive layer 122 includes a first current collector portion 124 and a first tab portion 126. The negative electrode layer 122 is disposed on at least a portion of the first current collector portion 124. In certain aspects, the negative electrode layer 122 extends over substantially an entire surface of the first current collector portion 124, as shown.

The first tab portion 126 is at least partially defined by a first perimeter 128. The first perimeter 128 may be substantially rectangular. The negative electrode layer 122 may be at least partially defined by a second perimeter 130. The second perimeter 130 may be substantially rectangular. The first perimeter 128 and the second perimeter 130 may share one side.

The negative electrode layer 122 includes a first electrode dimension or electrode length 132 and a second electrode dimension or electrode width 134. The first electrode dimension 132 is greater than the second electrode dimension 134. The negative electrode layer 122 includes an edge 136 extending substantially parallel to the first dimension 132. The first tab portion 126 extends continuously along substantially the entire edge 136. An electrode-tab interface 138 is coextensive with the edge 136. Accordingly, the electrode-tab interface 138 has an interface length 140 of about 100% of the first electrode dimension 132.

In certain aspects, the interface length 140 is greater than or equal to about 15% to less than or equal to about 48% of the second perimeter 130. For example, the interface length 140 may be greater than or equal to about 15% to less than or equal to about 25% of the second perimeter 130, greater than or equal to about 25% to less than or equal to about 35% of the second perimeter 130, or greater than or equal to about 35% to less than or equal to about 45% of the second perimeter 130.

The first tab portion 126 has a first tab dimension or tab length 142 and a second tab dimension or tab width 144. The first tab dimension 142 extends substantially parallel to the edge 136 and the first electrode dimension 132. The second tab dimension 144 extends substantially perpendicular to the edge 136 and the first electrode dimension 132.

With reference to FIGS. 3E-3F, the positive electrode component 116 includes a second electrically-conductive layer 150 and a positive electrode layer 152. The second electrically-conductive layer 150 includes a second current collector portion 154 and a second tab portion 156. Except for materials of construction, described in greater detail below, and orientation within the electrochemical cell 112, the positive electrode component 116 may be similar to the negative electrode component 114. In each electrochemical cell 112, an orientation of the positive electrode component 116 may be 180° from that of the negative electrode component 114.

Referring to FIG. 3G, an electrochemical cell assembly 160 is provided. The electrochemical cell assembly 160 includes the plurality of electrochemical cells 112. The electrochemical cells 112 may be electrically connected in series or parallel at respective first and second tab portions 126, 156.

The electrochemical cell assembly 160 further includes a distinct negative tab component 162 and a distinct positive tab component 164. The negative tab component 162 includes a first internal portion 166 and a first terminal portion 168. The negative tab component 162 may be substantially L-shaped. The first internal portion 166 may extend along substantially the entire first electrode dimension 132. The first terminal portion 168 may extend along at least a portion of the second electrode dimension 134.

The negative tab component 162 includes a first seal 172 that is disposed between the first internal portion 166 and the first terminal portion 168. The first internal portion 166 is coupled to the first tab portion 126 by a plurality of first welds 174. The first welds 174 may also couple the first tab portions 126 to one another (such as when the electrochemical device 110 includes more than one electrochemical cell 112).

The positive tab component 164 includes a second internal portion 176 and a second terminal portion 178. The positive tab component 164 may be substantially L-shaped. The second internal portion 176 may extend along substantially the entire first electrode dimension. The second terminal portion 178 may extend along at least a portion of the second electrode dimension 134.

The positive tab component 164 includes a second seal 180 that is disposed between the second internal portion 176 and the second terminal portion 178. The second internal portion 176 is coupled to the second tab portion 156 by a plurality of second welds 182. The plurality of second welds 182 may also couple the second tab portions 156 to one another (such as when the electrochemical device 110 includes a plurality of electrochemical cells 112). Each first weld 174 and second weld 182 has a first weld dimension or weld length 184 substantially parallel to the edge 136 and a second weld dimension or weld width 186 substantially perpendicular to the edge 136, as will be described in greater detail below.

During operation of the electrochemical device 110, at least a portion of the current flows substantially parallel to the second electrode dimension 134. For example, current flow during discharge may generally sequentially follow the paths indicated at 188-1 and 188-2. Because at least a portion of the current flows across the shorter dimension (i.e., the second electrode dimension 134), current density is more uniform across the negative and positive electrode layers 122, 152 and generally lower compared to cells having longer current paths (e.g., the electrochemical cell 50 of FIG. 2). The large interface length 140 also facilitates reduced localized current density compared to cells having smaller interface lengths (e.g., the electrochemical cell 50 of FIG. 2).

Returning to FIG. 3A, the housing 64 includes a pair of primary sides 190 substantially parallel to the first electrode dimension 132 and a pair of secondary sides 192 substantially parallel to the second electrode dimension 134. The primary sides 190 are longer than the secondary sides 192. The first and second terminal portions 168, 178 are disposed on one of the secondary sides 192. More particularly, the terminal portions 168, 178 are both disposed on a common secondary side 194.

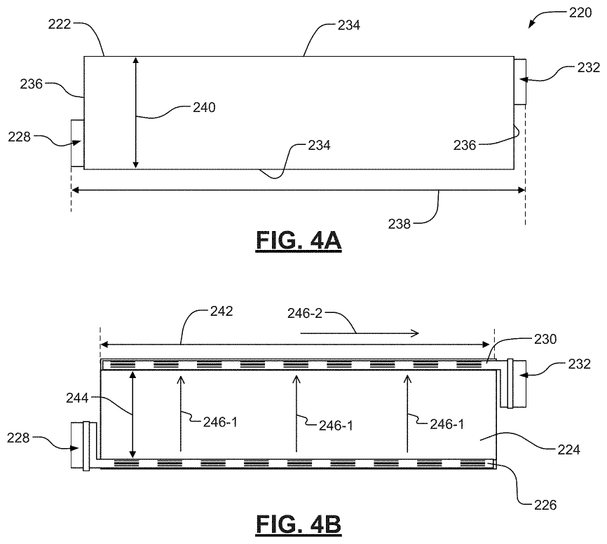

The electrochemical device 110 may have a first total dimension or total length 196 and a second total dimension or total width 198. Arranging both of the terminal portions 168, 178 on the common side 194 may facilitate an increase in energy density. More particularly, when the terminal portions 168, 178 are arranged on the common side 194, the first electrode dimension 132 can be increased while maintaining the first total dimension 196 compared to electrochemical devices having terminals disposed on opposite secondary sides (see, e.g., electrochemical device 220 of FIGS. 4A-4B).

Each of the terminal portions 168, 178 may have a first terminal dimension or terminal length 200 substantially parallel to an adjacent electrode edge and a second terminal dimension or width 202 substantially perpendicular to an adjacent electrode edge, as will be described in greater detail below.

### FIGS. 4A-4B

With reference to FIGS. 4A-4B, another electrochemical device 220 according to various aspects of the present disclosure is provided. The electrochemical device 220 may include an electrically-insulating housing 222, a plurality of electrode components 224, a plurality of electrode-separator systems (not shown), a negative tab component 226 having a first terminal portion 228, and a positive tab component 230 having a second terminal portion 232. The electrode components 224 may be similar to the negative and positive electrode components 114, 116 of the electrochemical device 110 of FIGS. 3A-3G.

The housing 222 may generally include a pair of primary sides 234 and a pair of secondary sides 236. The primary sides 234 are longer than the secondary sides 236. The terminal portions 228, 232 are disposed on opposing secondary sides 236.

The electrochemical device 220 defines a first total dimension or total length 238 and a second total dimension or total width 240. The plurality of electrode components 224 extend along a first electrode dimension or electrode length 242 and a second electrode dimension or electrode width 244. When the first total dimension 238 is the same as the first total dimension 196 of FIG. 3A, the first electrode dimension 242 is less than the first electrode dimension 132 of FIG. 3A. Current flow direction during discharge is generally indicated at 246-1 and 246-2.

### FIGS. 5A-5F

With reference to FIGS. 5A-5F, yet another electrochemical device 270 according to various aspects of the present disclosure is provided. The electrochemical device 270 includes one or more electrochemical cells 272. Each electrochemical cell 272 includes a negative electrode component 274, a positive electrode component 276, and an electrolyte separator system (see, e.g., electrolyte-separator system 118 of FIG. 3B). Adjacent electrochemical cells 272 are separated by additional electrolyte separator systems.

With reference to FIGS. 5B-5C, the negative electrode component 274 includes a first electrically-conductive layer 277 and a negative electrode layer 278. The first electrically-conductive layer 277 includes a first current collector portion 280 and a first tab portion 282. The negative electrode layer 278 is disposed on at least a portion of the first current collector portion 280, such as substantially an entire surface of the first current collector portion 280, as shown.

The first tab portion 282 is at least partially defined by a first perimeter 284 and the negative electrode layer 278 is at least partially defined by a second perimeter 285. The first perimeter 284 may be substantially L-shaped. The second perimeter 285 may be substantially rectangular.

The first perimeter 284 and the second perimeter 285 share at least portions of two sides. An electrode-tab interface 286 extends between the first tab portion 282 and the negative electrode layer 278. In certain aspects, a total interface length is a sum of a first interface length 287-1 (along the first edge 292) and a second interface length 287-2 (along the second edge 294). The total interface length is greater than or equal to about 1.5% to less than or equal to about 50% of the second perimeter 285. For example, the interface length may be greater than or equal 1.5% to less than or equal to about 10% of the second perimeter 285, greater than or equal to about 10% to less than or equal to about 20% of the second perimeter 285, greater than or equal to about 20% to less than or equal to about 30% of the second perimeter 285, greater than or equal to about 30% to less than or equal to about 40% of the second perimeter 285, or greater than or equal to about 40% to less than or equal to about 50% of the second perimeter 285.

The negative electrode layer 278 includes a first electrode dimension or electrode length 288 and a second electrode dimension or electrode width 290, with the first electrode dimension 288 being greater than the second electrode dimension 290. The negative electrode layer 278 includes a first edge 292 substantially parallel to the first electrode dimension 288 and a second edge 294 substantially perpendicular to the first edge 292. The first tab portion 282 extends continuously across at least a portion of the first edge 292 and at least a portion of the second edge 294. In certain aspects, the first tab portion 282 extends across substantially the entire first edge 292 and a portion of the second edge 294, as shown.

The total interface length may be greater than or equal to about 50% of the first electrode dimension 288, optionally greater than or equal to about 60% of the first electrode dimension 288, optionally greater than or equal to about 70% of the first electrode dimension 288, optionally greater than or equal to about 80% of the first electrode dimension 288, optionally greater than or equal to about 90% of the first electrode dimension 288, optionally greater than or equal to about 100% of the first electrode dimension 288, optionally greater than or equal to about 110% of the first electrode dimension 288, or optionally greater than or equal to about 120% of the first electrode dimension 288.

As best shown in FIG. 5C, the first electrically conductive layer 277 includes a third perimeter 296. The third perimeter 296 is a concave polygon. A notch 298 is defined by a concave portion 297 of the third perimeter 296. As used herein, the term “concave polygon” refers to a polygon having at least one interior angle that is greater than 180°.

Referring to FIGS. 5D-5E, the positive electrode component 276 includes a second electrically-conductive layer 310 and a positive electrode layer 312. The second electrically-conductive layer 310 includes a second current collector portion 314 and a second tab portion 316. Except for materials of construction, described in greater detail below, and orientation within the electrochemical cell 272, the positive electrode component 276 may be similar to the negative electrode component 274. In each electrochemical cell 272, an orientation of the positive electrode component 276 may be 180° from that of the negative electrode component 274.

With Reference to FIG. 5F, an electrochemical cell assembly 320 is provided. The electrochemical cell assembly 320 includes the one or more electrochemical cells 272, which may be connected in series and/or parallel at respective first and second tab portions 282, 316. The electrochemical cell assembly 320 further includes a distinct negative tab component 322 and a distinct positive tab component 324. The negative tab component 322 includes a first internal portion 326, a first terminal portion 328, and a first seal 329. The positive tab component 324 includes a second internal portion 330, a second terminal portion 332, and a second seal 333. The first and second internal portions 326, 330 may extend substantially parallel to the second electrode dimension 290.

One or more first welds 334 may couple the negative tab component 322 to the first tab portion 282. One or more second welds 336 may couple the positive tab component 324 to the second tab portion 316. A plurality of third welds 338 may couple adjacent first tab portions 282 to one another (if the electrochemical device 270 includes more than one electrochemical cell 272). A plurality of fourth welds 340 may couple adjacent second tab portions 316 to one another (if the electrochemical device 270 includes more than one electrochemical cell 272).

During operation of the electrochemical device 270, at least a portion of the current flows substantially parallel to the second electrode dimension 290. For example, current flow during discharge may generally sequentially follow the paths indicated at 342-1 and 342-2. Thus, the electrochemical device 270 provides similar advantages with respect to current density and uniformity as the electrochemical device 110 of FIG. 3A. Furthermore, in certain aspects, the electrochemical device 270 may have lower localized current densities than the electrochemical device 110 of FIG. 3A due to the increased total interface length.

Returning to FIG. 5A, the electrochemical device 270 includes an electrically-insulating housing 350. The housing 350 includes a pair of primary sides 352 and a pair of substantially parallel secondary sides 354. The negative and positive tab components 322, 324 are disposed on opposing secondary sides 354.

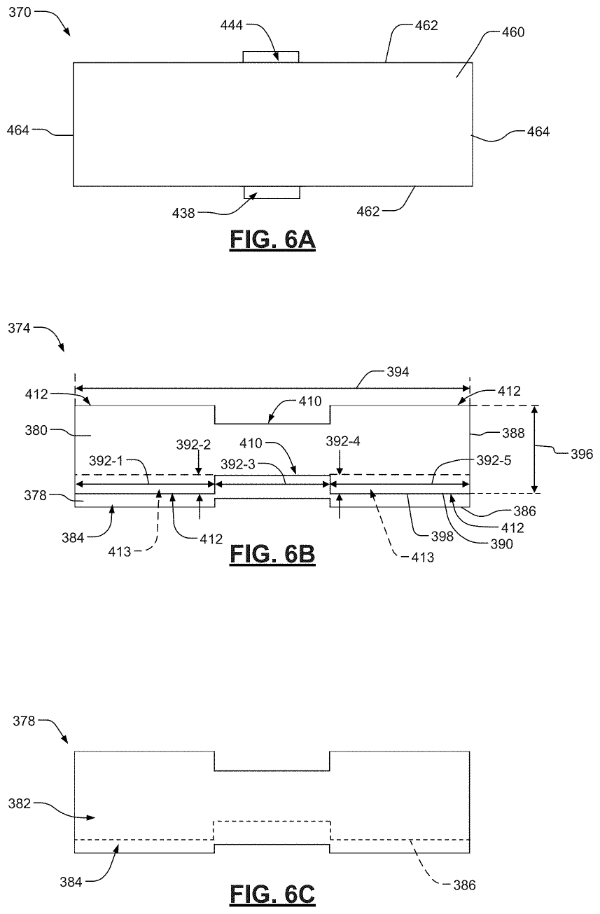

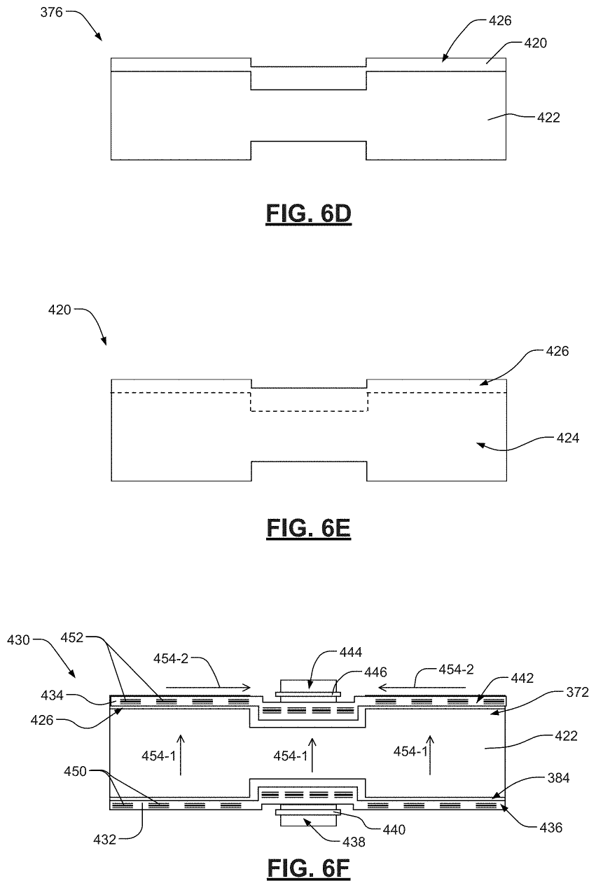

### FIGS. 6A-6F

With reference to FIGS. 6A-6F, yet another electrochemical device 370 according to various aspects of the present disclosure is provided. The electrochemical device 370 includes one or more electrochemical cells 372 (FIG. 6F). Each electrochemical cell 372 includes a negative electrode component 374, a positive electrode component 376, and an electrolyte separator system (see, e.g., electrolyte-separator system 118 of FIG. 3B). Adjacent electrochemical cells 372 are separated by additional electrolyte separator systems.

With reference to FIGS. 6B-6C, the negative electrode component 374 includes a first electrically-conductive layer 378 and a negative electrode layer 380. The first electrically-conductive layer 378 includes a first current collector portion 382 and a first tab portion 384. The negative electrode layer 380 is disposed on at least a portion of the first current collector portion 382, such as substantially an entire surface of the first current collector portion 382, as shown.

The first tab portion 384 is at least partially defined by a first perimeter 386 and the negative electrode layer 380 is at least partially defined by a second perimeter 388. The second perimeter 388 may have second order rotational symmetry. In certain variations, the second perimeter 388 may define a dog bone shape. The first perimeter 386 and the second perimeter 388 share at least portions of five sides. An electrode-tab interface 390 extends between the first tab portion 384 and the negative electrode layer 380.

A total interface length is a sum of a first interface length 392-1, a second interface length 392-2, a third interface length 392-3, a fourth interface length 392-4, and a fifth interface length 392-5. In certain aspects, the total interface length is greater than or equal to about 0.8% to less than or equal to about 48% of the second perimeter 388. For example, the total interface length may be greater than or equal 0.8% to less than or equal to about 10% of the second perimeter 388, greater than or equal to about 10% to less than or equal to about 20% of the second perimeter 388, greater than or equal to about 20% to less than or equal to about 30% of the second perimeter 388, greater than or equal to about 30% to less than or equal to about 40% of the second perimeter 388, or greater than or equal to about 40% to less than or equal to about 48% of the second perimeter 388.

The negative electrode layer 380 includes a first electrode dimension or electrode length 394 and a second electrode dimension or electrode width 396. The second dimension 396 may be a maximum second dimension. The first electrode dimension 394 greater than the second electrode dimension 396. The negative electrode layer 380 includes an edge 398 substantially parallel to the first electrode dimension 394. The first tab portion 282 extends continuously across at least a portion of the edge 398. In certain aspects, the first tab portion 384 extends across substantially the entire first electrode dimension 394.

The total interface length of the electrode-tab interface 390 may be greater than or equal to about 50% of the first electrode dimension 394, optionally greater than or equal to about 60% of the first electrode dimension 394, optionally greater than or equal to about 70% of the first electrode dimension 394, optionally greater than or equal to about 80% of the first electrode dimension 394, optionally greater than or equal to about 90% of the first electrode dimension 394, or optionally greater than or equal to about 100% of the first electrode dimension 394.

The second perimeter 388 may be a concave polygon including two opposing concave portions 410. The first tab portion 384 is disposed along the edge 398, at least partially within one of the concave portions 410. Thus, at least a portion of the first tab portion 384 is recessed with respect to the edge 398. Each concave portion 410 is disposed between two convex portions 412. The convex portions 412 include regions 413 of the negative electrode layer 380. Accordingly, the negative electrode component 374 may have a higher energy density (e.g., 0.5-3% higher) compared to an electrode component having protruding tabs that are not disposed between regions of electroactive material (see, e.g., negative electrode 52 and negative tab 56 of FIG. 2).

Referring to FIGS. 6D-6E, the positive electrode component 376 includes a second electrically-conductive layer 420 and a positive electrode layer 422. The second electrically-conductive layer 420 includes a second current collector portion 424 and a second tab portion 426. Except for materials of construction, described in greater detail below, and orientation within the electrochemical cell 372, the positive electrode component 376 may be similar to the negative electrode component 374. In each electrochemical cell 372, an orientation of the positive electrode component 376 may be 180° from that of the negative electrode component 374.

With reference to FIG. 6F, an electrochemical assembly 430 is provided. The electrochemical cell assembly 430 includes the one or more electrochemical cells 372, which may be connected in series and/or parallel at respective first and second tab portions 384, 426. The electrochemical cell assembly 430 further includes a distinct negative tab component 432 and a distinct positive tab component 434. The negative tab component 432 includes a first internal portion 436, a first terminal portion 438, and a first seal 440. The positive tab component 434 includes a second internal portion 442, a second terminal portion 444, and a second seal 446. The first and second tab components 432, 434 may extend substantially parallel to the first electrode dimension 394. In certain aspects, the first and second internal portions 436, 442 may be shorter, such that they are only present adjacent to the concave portions 410.

A plurality of first welds 450 may couple the negative tab component 432 to the first tab portion 384. The plurality of first welds 450 may also couple first tab portions 384 to one another (such as when the electrochemical device 370 includes more than one electrochemical cell 372). A plurality of second welds 452 may couple the positive tab component 434 to the second tab portion 426. The plurality of second welds 452 may also couple second tab portions 426 to one another (such as when the electrochemical device 370 includes more than one electrochemical cell 372).

During operation of the electrochemical device 370, at least a portion of the current flows substantially parallel to the second electrode dimension 396. For example, current flow during discharge may generally sequentially follow the paths indicated at 454-1 and 454-2. Thus, the electrochemical device 370 provides similar advantages with respect to current density as the electrochemical device 110 of FIG. 3A.

Returning to FIG. 6A, the electrochemical device 370 includes an electrically-insulating housing 460. The housing 460 includes a pair of primary sides 462 and a pair of substantially parallel secondary sides 464. The negative and positive tab components 432, 434 are disposed on opposing primary sides 462. In certain aspects, the terminal portions 438, 444 may be centered with respect to the first electrode dimension 394.

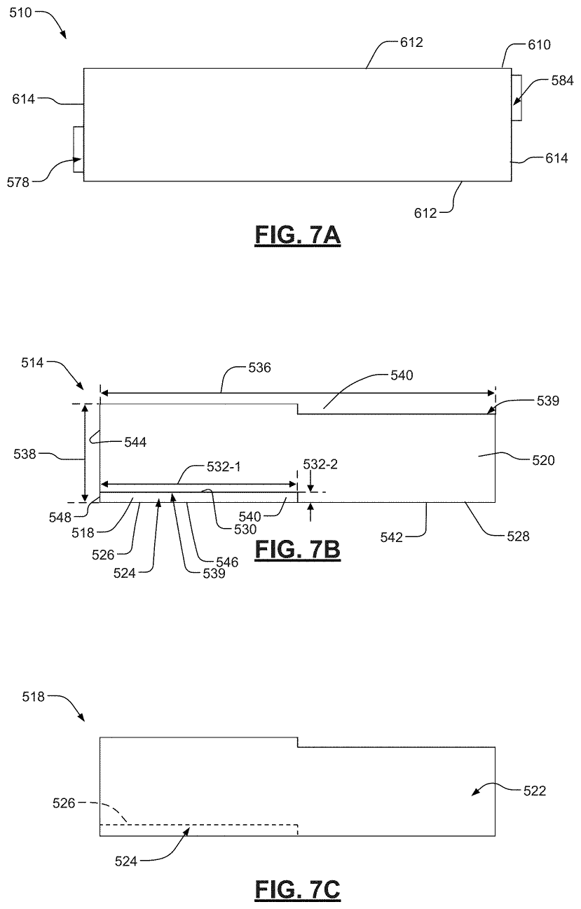

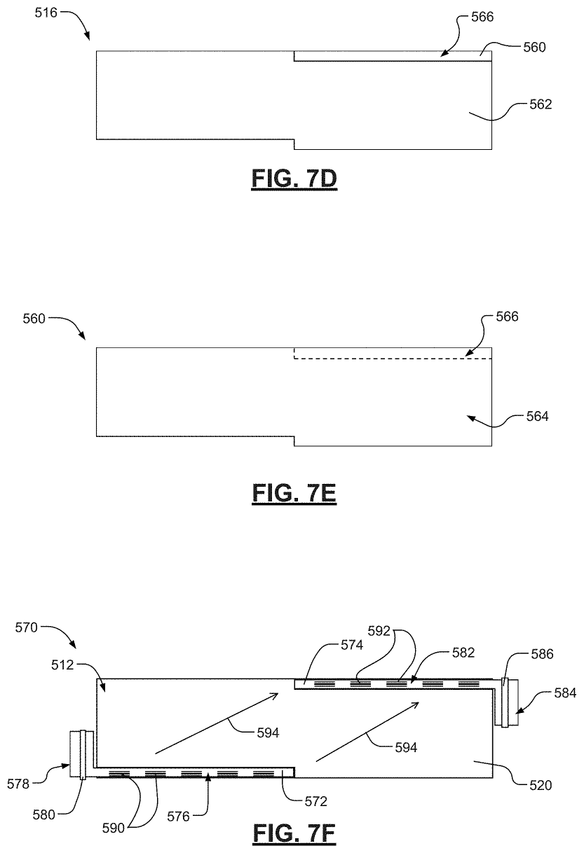

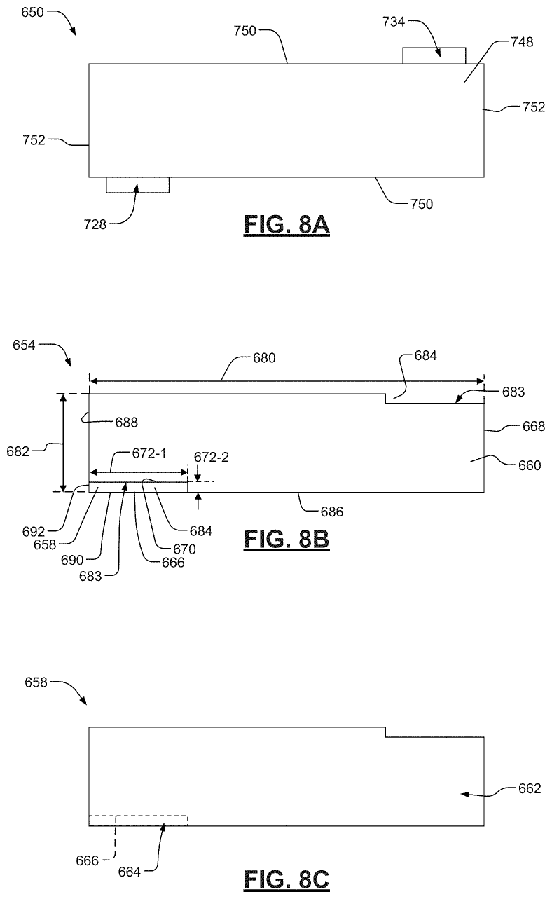

### FIGS. 7A-7F

With reference to FIGS. 7A-7F, yet another electrochemical device 510 according to various aspects of the present disclosure is provided. The electrochemical device 510 includes one or more electrochemical cells 512 (FIG. 7F). Each electrochemical cell 512 includes a negative electrode component 514, a positive electrode component 516, and an electrolyte separator system (see, e.g., electrolyte-separator system 118 of FIG. 3B). Adjacent electrochemical cells 512 are separated by additional electrolyte separator systems.

With reference to FIGS. 7B-7C, the negative electrode component 514 includes a first electrically-conductive layer 518 and a negative electrode layer 520. The first electrically-conductive layer 518 includes a first current collector portion 522 and a first tab portion 524. The negative electrode layer 520 is disposed on at least a portion of the first current collector portion 522, such as substantially an entire surface of the first current collector portion 522, as shown.

The first tab portion 524 is at least partially defined by a first perimeter 526 and the negative electrode layer 520 is at least partially defined by a second perimeter 528. The first perimeter 526 may be substantially rectangular. The second perimeter 528 may be a concave polygon. The first perimeter 526 and the second perimeter 528 share two sides. An electrode-tab interface 530 extends between the first tab portion 524 and the negative electrode layer 520.

The electrode-tab interface 530 has a total interface length that is a sum of a first interface length 532-1 and a second interface length 532-2. In certain aspects, the total interface length is greater than or equal to about 0.15% to less than or equal to about 25% of the second perimeter 528. For example, the total interface length may be greater than or equal to about 0.15% to less than or equal to about 5% of the second perimeter 528, greater than or equal to about 5% to less than or equal to about 10% of the second perimeter 528, greater than or equal to about 10% to less than or equal to about 15% of the second perimeter 528, greater than or equal to about 15% to less than or equal to about 20% of the second perimeter 528, or greater than or equal to about 20% to less than or equal to about 25% of the second perimeter 528.

The negative electrode layer 520 includes a first electrode dimension or electrode length 536 and a second electrode dimension or electrode width 538. The first and second electrode dimensions 536, 538 may be maximum first and second electrode dimensions. The first electrode dimension 536 is greater than the second electrode dimension 538. The total interface length of the electrode-tab interface 530 may be greater than or equal to about 5% of the first electrode dimension 536, optionally greater than or equal to about 10% of the first electrode dimension 536, optionally greater than or equal to about 15% of the first electrode dimension 536, optionally greater than or equal to about 20% of the first electrode dimension 536, optionally greater than or equal to about 25% of the first electrode dimension 536, or optionally greater than or equal to about 30% of the first electrode dimension 536, optionally greater than or equal to about 35% of the first electrode dimension 536, optionally greater than or equal to about 40% of the first electrode dimension 536, or optionally greater than or equal to about 45% of the first electrode dimension 536.

Concave portions 539 of the second perimeter 528 define respective notches 540. The second perimeter 528 may have second order rotational symmetry. The first tab portion 524 may be at least partially disposed on one of the notches 540. Thus, at least a portion of the first tab portion 524 may be recessed with respect to a first edge 542 and a second edge 544 of the negative electrode layer 520. The first tab portions 524 may include a third edge 546 that extends collinear with the first edge 542 and a fourth edge 548 that extends collinear with the second edge 544. Thus, the first perimeter 526 may include the electrode-tab interface 530, the third edge 546, and the fourth edge 548. The second perimeter 528 may include the electrode-tab interface 530, the first edge 542, and the second edge 544.

Referring to FIGS. 7D-7E, the positive electrode component 516 includes a second electrically-conductive layer 560 and a positive electrode layer 562. The second electrically-conductive layer 560 includes a second current collector portion 564 and a second tab portion 566. Except for materials of construction, described in greater detail below, and orientation within the electrochemical cell 512, the positive electrode component 516 may be similar to the negative electrode component 514. In each electrochemical cell 512, an orientation of the positive electrode component 516 may be 180° from that of the negative electrode component 514.

With reference to FIG. 7F, an electrochemical assembly 570 is provided. The electrochemical cell assembly 570 includes the one or more electrochemical cells 512, which may be connected in series and/or parallel at respective first and second tab portions 524, 566. The electrochemical cell assembly 570 further includes a distinct negative tab component 572 and a distinct positive tab component 574. The negative tab component 572 includes a first internal portion 576, a first terminal portion 578, and a first seal 580. The positive tab component 574 includes a second internal portion 582, a second terminal portion 584, and a second seal 586. The first and second internal portions 576, 582 may extend substantially parallel to the first electrode dimension 536. The first and second terminal portions 578, 584 may extend substantially parallel to the second electrode dimension 538.

The first internal portion 576 of the negative tab component 572 is coupled to the first tab portion 524 by a plurality of first welds 590. The first welds 590 may also couple first tab portions 524 to one another (such as when the electrochemical device 510 includes more than one electrochemical cell 512). The second internal portion 582 of the positive tab component 574 is coupled to the second tab portion 566 by a plurality of second welds 592. The second welds 592 may also couple the second tab portions 566 to one another (such as when the electrochemical device 510 includes more than one electrochemical cell 512).

During operation of the electrochemical device 510, the current may flow in a diagonal direction. For example, current flow during discharge may generally follow the path indicated at 594. The path may be shorter than a path that is substantially parallel to the first electrode dimension 536. Thus, the electrochemical device 510 may facilitate improvements in current density compared to a cell having current that flows parallel to a first electrode dimension. Furthermore, compared to an electrode component having protruding tabs (see, e.g., electrochemical cell 50 of FIG. 2), the total interface length may be higher due to addition of the second interface length 532-2. The higher total interfaces facilitates a reduction in localized current density.

Returning to FIG. 7A, the electrochemical device 510 includes an electrically-insulating housing 610. The housing 610 includes a pair of opposing primary sides 612 and a pair of opposing secondary sides 614. The first and second terminal portions 578, 584 are disposed on opposing secondary sides 614. However, in various alternative aspects, negative and positive tab components may be arranged so first and second terminal portions are disposed on a common secondary side, similar to the negative and positive tab components 162, 164 of FIG. 3G.

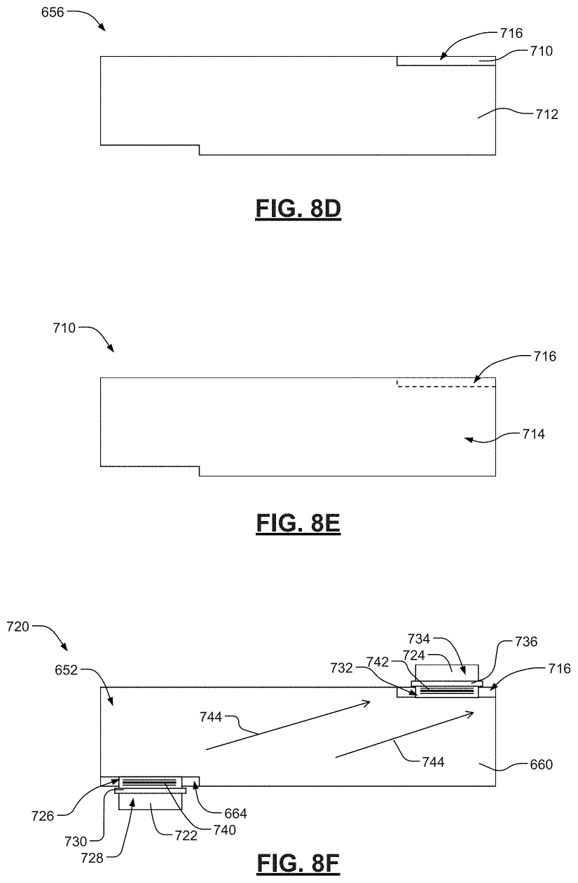

### FIGS. 8A-8F

With reference to FIGS. 8A-8F, yet another electrochemical device 650 according to various aspects of the present disclosure is provided. The electrochemical device 650 includes one or more electrochemical cells 652 (FIG. 8F). Each electrochemical cell 652 includes a negative electrode component 654, a positive electrode component 656, and an electrolyte separator system (see, e.g., electrolyte-separator system 118 of FIG. 3B). Adjacent electrochemical cells 652 are separated by additional electrolyte separator systems.

With reference to FIGS. 8B-8C, the negative electrode component 654 includes a first electrically-conductive layer 658 and a negative electrode layer 660. The first electrically-conductive layer 658 includes a first current collector portion 662 and a first tab portion 664. The negative electrode layer 660 is disposed on at least a portion of the first current collector portion 662, such as substantially an entire surface of the first current collector portion 662, as shown.

The first tab portion 664 is at least partially defined by a first perimeter 666 and the negative electrode layer 660 is at least partially defined by a second perimeter 668. The first perimeter 666 may be substantially rectangular. The second perimeter 668 may be a concave polygon. The first perimeter 666 and the second perimeter 668 share two sides. An electrode-tab interface 670 extends between the first tab portion 664 and the negative electrode layer 660.

The electrode-tab interface 670 has a total interface length that is a sum of a first interface length 672-1 and a second interface length 672-2. In certain aspects, the total interface length is greater than or equal to about 0.8% to less than or equal to about 25% of the second perimeter 668. For example, the total interface length may be greater than or equal to about 0.8% to less than or equal to about 5% of the second perimeter 668, greater than or equal to about 5% to less than or equal to about 10% of the second perimeter 668, greater than or equal to about 10% to less than or equal to about 15% of the second perimeter 668, or greater than or equal to about 15% to less than or equal to about 22% of the second perimeter 668.

The negative electrode layer 660 includes a first electrode dimension or electrode length 680 and a second electrode dimension or electrode width 682. The first and second electrode dimensions 680, 682 may be maximum first and second electrode dimensions. The first electrode dimension 680 is greater than the second electrode dimension 682. The total interface length of the electrode-tab interface 670 may be greater than or equal to about 5% of the first electrode dimension 680, optionally greater than or equal to about 10% of the first electrode dimension 680, optionally greater than or equal to about 15% of the first electrode dimension 680, optionally greater than or equal to about 20% of the first electrode dimension 680, optionally greater than or equal to about 25% of the first electrode dimension 680, or optionally greater than or equal to about 30% of the first electrode dimension 680, optionally greater than or equal to about 35% of the first electrode dimension 680, optionally greater than or equal to about 40% of the first electrode dimension 680, or optionally greater than or equal to about 45% of the first electrode dimension 680.

Concave portions 683 of the second perimeter 668 define respective notches 684. The second perimeter 668 may have second order rotational symmetry. The first tab portion 664 may be at least partially disposed on one of the notches 684. The electrode layer may include a first edge 686 substantially parallel to the first electrode dimension 680 and a second edge 688 substantially parallel to the second electrode dimension 682. The first tab portion 664 may include a third edge 690 that extends collinear with the first edge 686 and a fourth edge 692 that extends collinear with the second edge 688. Accordingly, the first perimeter 666 may include the electrode-tab interface 670, the third edge 690, and the fourth edge 692. The second perimeter 668 may include the electrode-tab interface 670, the first edge 686, and the second edge 688.

Referring to FIGS. 8D-8E, the positive electrode component 656 includes a second electrically-conductive layer 710 and a positive electrode layer 712. The second electrically-conductive layer 710 includes a second current collector portion 714 and a second tab portion 716. Except for materials of construction, described in greater detail below, and orientation within the electrochemical cell 652, the positive electrode component 656 may be similar to the negative electrode component 654. In each electrochemical cell 652, an orientation of the positive electrode component 656 may be 180° from that of the negative electrode component 654.

With reference to FIG. 8F, an electrochemical assembly 720 is provided. The electrochemical cell assembly 720 includes the one or more electrochemical cells 652, which may be connected in series and/or parallel at respective first and second tab portions 664, 716. The electrochemical cell assembly 720 further includes a distinct negative tab component 722 and a distinct positive tab component 724. The negative tab component 722 includes a first internal portion 726, a first terminal portion 728, and a first seal 730. The positive tab component 724 includes a second internal portion 732, a second terminal portion 734, and a second seal 736. The negative and positive tab components 722, 724 extend substantially parallel to the first electrode dimension 680.

The first internal portion 726 of the negative tab component 722 is coupled to the first tab portion 664 by a first weld 740. The first weld 740 may also couple first tab portions 664 to one another (such as when the electrochemical device 650 includes more than one electrochemical cell 652). The second internal portion 732 of the positive tab component 724 is coupled to the second tab portion 716 by a second weld 742. The second weld 742 may also couple the second tab portions 716 to one another (such as when the electrochemical device 650 includes more than one electrochemical cell 652).

During operation of the electrochemical device 650, the current flows in a diagonal path. For example, current flow during discharge may generally follow the path indicated at 744. The diagonal path may generally be shorter than a path that is parallel to the first electrode dimension 680. Thus, the electrochemical device 650 facilitates improvements in the uniformity of current density. Furthermore, compared to an electrode component having protruding tabs (see, e.g., electrochemical cell 50 of FIG. 2), the total interface length may be higher due to addition of the second interface length 672-2. The higher total interface length facilitates a reduction in localized current density.

Returning to FIG. 8A, the electrochemical device 650 includes an electrically-insulating housing 748. The housing 748 includes a pair of opposing primary sides 750 and a pair of opposing secondary sides 752. The first and second terminal portions 728, 734 are disposed on opposing primary sides 750.

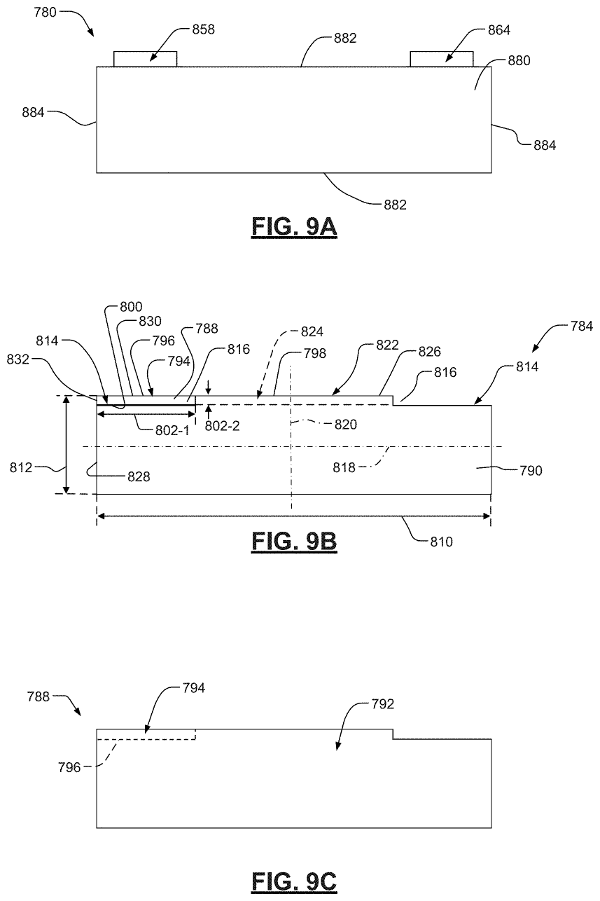

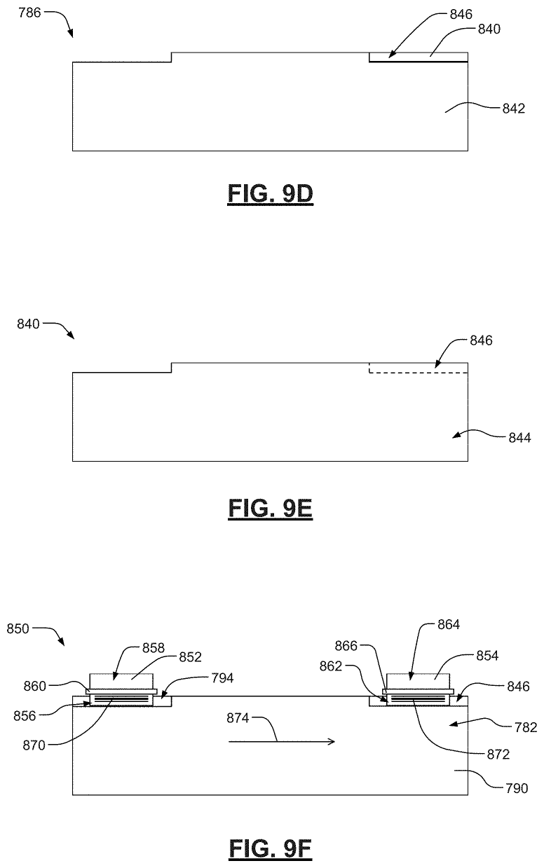

### FIG. 9A-9F

With reference to FIGS. 9A-9F, yet another electrochemical device 780 according to various aspects of the present disclosure is provided. The electrochemical device 780 includes one or more electrochemical cells 782 (FIG. 9F). Each electrochemical cell 782 includes a negative electrode component 784, a positive electrode component 786, and an electrolyte separator system (see, e.g., electrolyte-separator system 118 of FIG. 3B). Adjacent electrochemical cells 782 are separated by additional electrolyte separator systems.

With reference to FIGS. 9B-9C, the negative electrode component 784 includes a first electrically-conductive layer 788 and a negative electrode layer 790. The first electrically-conductive layer 788 includes a first current collector portion 792 and a first tab portion 794. The negative electrode layer 790 is disposed on at least a portion of the first current collector portion 792, such as substantially an entire surface of the first current collector portion 792, as shown.

The first tab portion 794 is at least partially defined by a first perimeter 796 and the negative electrode layer 790 is at least partially defined by a second perimeter 798. The first perimeter 796 may be substantially rectangular. The second perimeter 798 may be a concave polygon. The first perimeter 796 and the second perimeter 798 share two sides. An electrode-tab interface 800 extends between the first tab portion 794 and the negative electrode layer 790.

The electrode-tab interface 800 has a total interface length that is a sum of a first interface length 802-1 and a second interface length 802-2. In certain aspects, the total interface length is greater than or equal to about 0.8% to less than or equal to about 25% of the second perimeter 798. For example, the total interface length may be greater than or equal to about 0.8% to less than or equal to about 5% of the second perimeter 798, greater than or equal to about 5% to less than or equal to about 10% of the second perimeter 798, greater than or equal to about 10% to less than or equal to about 15% of the second perimeter 798, or greater than or equal to about 15% to less than or equal to about 22% of the second perimeter 798.

The negative electrode layer 790 includes a first electrode dimension or electrode length 810 and a second electrode dimension or electrode width 812. The first and second electrode dimensions 810, 812 may be maximum first and second electrode dimensions. The first electrode dimension 810 is greater than the second electrode dimension 812. The total interface length of the electrode-tab interface 800 may be greater than or equal to about 5% to less than about 50% of the first electrode dimension 810, optionally greater than or equal to about 10% to less than about 50% of the first electrode dimension 810, optionally greater than or equal to about 15% to less than about 50% of the first electrode dimension 810, optionally greater than or equal to about 20% to less than about 50% of the first electrode dimension 810, optionally greater than or equal to about 25% to less than about 50% of the first electrode dimension 810, or optionally greater than or equal to about 30% to less than about 50% of the first electrode dimension 810, optionally greater than or equal to about 35% to less than about 50% of the first electrode dimension 810, optionally greater than or equal to about 40% to less than about 50% of the first electrode dimension 810, or optionally greater than or equal to about 45% to less than about 50% of the first electrode dimension 810.

Concave portions 814 of the second perimeter 798 define respective notches 816. The negative electrode layer 790 may include a first axis 818 and a second axis 820. The first axis 818 extends substantially parallel to the first electrode dimension 810 and through a midpoint of the second electrode dimension 812. The second axis 820 extends substantially parallel to the second electrode dimension 812 and through a midpoint of the first electrode dimension 810. The negative electrode layer 790 may have reflective symmetry about the second axis 820. However, in various alternative aspects, concave portions of a second perimeter may be arranged so that an electrode layer has reflective symmetry about the first axis 818. Thus, an electrode layer may have reflective symmetry about one of the first axis 818 or the second axis 820.

The concave portions 814 may be spaced apart from one another along the first axis 818. A convex portion 822 of the second perimeter 798 may be disposed between the two concave portions 814. Because the convex portion 822 includes the negative electrode layer 790 in the region 824, the negative electrode component 784 may have a higher energy density (e.g., by 0.5-3%) compared to an electrode component having protruding tabs without electroactive material disposed therebetween.

The first tab portion 794 may be at least partially disposed on one of the notches 816 such that at least a portion of the first tab portion 794 is recessed with respect to the negative electrode layer 790. The negative electrode layer 790 may include a first edge 826 substantially parallel to the first electrode dimension 810 and a second edge 828 substantially parallel to the second electrode dimension 812. The first tab portion 794 may include a third edge 830 that extends collinear with the first edge 826 and a fourth edge 832 that extends collinear with the second edge 828.

Referring to FIGS. 9D-9E, the positive electrode component 786 includes a second electrically-conductive layer 840 and a positive electrode layer 842. The second electrically-conductive layer 840 includes a second current collector portion 844 and a second tab portion 846. Except for materials of construction, described in greater detail below, and orientation within the electrochemical cell 782, the positive electrode component 786 may be similar to the negative electrode component 784. In each electrochemical cell 782, an orientation of the positive electrode component 786 may be 180° from that of the negative electrode component 784.

With reference to FIG. 9F, an electrochemical assembly 850 is provided. The electrochemical cell assembly 850 includes the one or more electrochemical cells 782, which may be connected in series and/or parallel at respective first and second tab portions 794, 846. The electrochemical cell assembly 850 further includes a distinct negative tab component 852 and a distinct positive tab component 854. The negative tab component 852 includes a first internal portion 856, a first terminal portion 858, and a first seal 860. The positive tab component 854 includes a second internal portion 862, a second terminal portion 864, and a second seal 866. The negative and positive tab components 852, 854 extend substantially parallel to the first electrode dimension 810.

The first internal portion 856 of the negative tab component 852 is coupled to the first tab portion 794 by a first weld 870. The first weld 870 may also couple first tab portions 794 to one another (such as when the electrochemical device 780 includes more than one electrochemical cell 782). The second internal portion 862 of the positive tab component 854 is coupled to the second tab portion 846 by a second weld 872. The second weld 872 may also couple the second tab portions 846 to one another (such as when the electrochemical device 780 includes more than one electrochemical cell 782).

During operation of the electrochemical device 780, the current flows in a path that is substantially parallel to the first electrode dimension 810. For example, current flow during discharge may generally follow the path indicated at 874. Compared to an electrode component having protruding tab portions (see, e.g., electrochemical cell 50 of FIG. 2), the total interface length may be higher due to the addition of the second interface length 802-2. The higher total interface length facilitates a reduction in localized current density.

Returning to FIG. 9A, the electrochemical device 780 includes an electrically-insulating housing 880. The housing 880 includes a pair of opposing primary sides 882 and a pair of opposing secondary sides 884. The first and second terminal portions 858, 864 are both disposed on one of the primary sides. Accordingly, similar to the electrochemical device 110 of FIG. 3A, within a given footprint, the electrochemical device 780 may have a higher energy density than an electrochemical cell having the same total dimensions with terminal portions disposed on opposing primary sides (e.g., electrochemical cell 652 of FIG. 8A). In various alternative aspects, the terminal portions may be disposed on a common secondary side.

### Dimensions

The following sections are generally applicable to the electrochemical devices 110, 220, 270, 370, 510, 650, 780 of FIGS. 3A-9F.

### Internal Tab Portions

As described above, internal tabs or tab portions according to various aspects of the present disclosure may be relatively large. Internal tab portions may have a first tab dimension or internal tab length substantially parallel to an adjacent electrode edge and a second tab dimension or internal tab width substantially perpendicular to the adjacent electrode edge. The first tab dimension may be greater than or equal to about 30 mm to less than or equal to about 1,000 mm, optionally greater than or equal to about 100 mm to less than or equal to about 800 mm, or optionally greater than or equal to about 200 mm to less than or equal to about 500 mm, by way of example. The second tab dimension may be greater than or equal to about 1.5 mm to less than or equal to about 100 mm, optionally greater than or equal to about 1.5 mm to less than or equal to about 10 mm, or optionally greater than or equal to about 2 mm to less than or equal to about 5 mm, by way of example. The internal tab may define a third tab dimension or thickness substantially perpendicular to the first tab dimension and the second tab dimension, by way of example. The third tab dimension may be greater than or equal to about 0.05 mm to less than or equal to about 0.4 mm, optionally greater than or equal to about 0.06 mm to less than or equal to about 0.3 mm, or optionally greater than or equal to about 0.1 mm to less than or equal to about 0.2 mm, by way of example. In certain aspects, the internal tab may define a surface area of greater than or equal to about 600 mm² to less than or equal to about 20,000 mm², optionally greater than or equal to about 600 mm² to less than or equal to about 10,000 mm², or optionally greater than or equal to about 800 mm² to less than or equal to about 4,000 mm², by way of example.

The internal tab extends along and is disposed adjacent to at least a portion of an edge of the electrode parallel to the electrode length. In certain aspects, the internal tab extends continuously around a corner of an electrode, between two perpendicular edges of the electrode. An interface length between the electrode and the internal tab may be greater than or equal to about 50% of the electrode length, optionally greater than or equal to about 55% of the electrode length optionally greater than or equal to about 60% of the electrode length, optionally greater than or equal to about 65% of the electrode length, optionally greater than or equal to about 70% of the electrode length, optionally greater than or equal to about 75% of the electrode length, optionally greater than or equal to about 80% of the electrode length, optionally greater than or equal to about 85% of the electrode length, optionally greater than or equal to about 90% of the electrode length, optionally greater than or equal to about 95% of the electrode length, or optionally greater than or equal to about 100% of the electrode length (e.g., when the internal tab extends along and is disposed adjacent to substantially the entire length and a portion of the width, as shown in FIG. 5B). The internal tab may share greater than or equal to one edge with the electrode (see, e.g., FIG. 3C), optionally greater than or equal to two edges (see, e.g., FIGS. 5B, 7B, 8B, 9B), optionally greater than or equal to three edges, optionally greater than or equal to four edges, or optionally greater than or equal to five edges (see, e.g., FIG. 6B).

The internal tab portions may be coupled to one another by one or more welds (see, e.g., pluralities of third and fourth welds 340, 338 of FIG. 5F). In various aspects, the relatively large internal tab portions provide space for an increased quantity of welds and/or increased weld sizes, thereby reducing a resistance between the internal tab portions and the distinct tab component compared to an electrochemical cell having smaller internal tab portions. An individual weld may have a first weld dimension or weld length substantially parallel to an adjacent electrode edge and a second weld dimension or weld width substantially perpendicular to the adjacent electrode edge. The weld length may be greater than or equal to about 30 mm to less than or equal to about 1,000 mm, optionally greater than or equal to about 100 mm to less than or equal to about 800 mm, or optionally greater than or equal to about 200 mm to less than or equal to about 500 mm, by way of example. The weld width may be greater than or equal to about 1 mm to less than or equal to about 10 mm, optionally greater than or equal to about 1.5 mm to less than or equal to about 6 mm, or optionally greater than or equal to about 2 mm to less than or equal to about 4 mm, by way of example. Accordingly, each individual weld may have an area of greater than or equal to about 30 mm² to less than or equal to about 10,000 mm², optionally greater than or equal to about 40 mm² to less than or equal to about 1,000 mm², greater than or equal to about 60 mm² to less than or equal to about 800 mm², or greater than or equal to about 80 mm² to less than or equal to about 600 mm².

### Distinct Tab Components

Each terminal portion may include a first terminal dimension or terminal length substantially parallel to an adjacent electrode edge and a second terminal dimension or terminal width substantially perpendicular to the adjacent electrode edge. The terminal length may be greater than or equal to about 30 mm to less than or equal to about 200 mm, optionally greater than or equal to about 40 mm to less than or equal to about 100 mm, or optionally greater than or equal to about 45 mm to less than or equal to about 60 mm, by way of example. The terminal width may be greater than or equal to about 20 mm to less than or equal to about 100 mm, optionally greater than or equal to about 30 mm to less than or equal to about 80 mm, or optionally greater than or equal to about 40 mm to less than or equal to about 60 mm, by way of example. Each distinct tab component may define a thickness substantially perpendicular to the terminal length and the terminal width. The thickness may be greater than or equal to about 0.15 mm to less than or equal to about 0.4 mm, optionally greater than or equal to about 0.2 mm to less than or equal to about 0.4 mm, or optionally greater than or equal to about 0.2 mm to less than or equal to about 0.3 mm.

The distinct tab components may be coupled to the respective internal tab portions by one or more welds (see, e.g., first and second welds 334, 336 of FIG. 5F). In various aspects, the relatively large internal tab portions provide space for an increased quantity of welds and/or increased weld sizes, thereby reducing a resistance between the internal tab portions and the distinct tab component compared to an electrochemical cell having smaller internal tab portions. An individual weld may have a first weld dimension or weld length substantially parallel to an adjacent electrode edge and a second weld dimension or weld width substantially perpendicular to the adjacent electrode edge. The weld length may be greater than or equal to about 30 mm to less than or equal to about 1,000 mm, optionally greater than or equal to about 100 mm to less than or equal to about 800 mm, or optionally greater than or equal to about 200 mm to less than or equal to about 500 mm, by way of example. The weld width may be greater than or equal to about 1 mm to less than or equal to about 10 mm, optionally greater than or equal to about 1.5 mm to less than or equal to about 6 mm, or optionally greater than or equal to about 2 mm to less than or equal to about 4 mm, by way of example. Accordingly, each individual weld may have an area of greater than or equal to about 30 mm² to less than or equal to about 10,000 mm², optionally greater than or equal to about 40 mm² to less than or equal to about 1,000 mm², greater than or equal to about 60 mm² to less than or equal to about 800 mm², or greater than or equal to about 80 mm² to less than or equal to about 600 mm².

### Materials

The subsections below are applicable to the electrochemical devices 110, 220, 270, 370, 510, 650, 780 of FIGS. 3A-9G.

### Electrodes

The negative and positive electrode layers may include respective negative and positive electroactive materials and any additional components described above in conjunction with FIG. 1. The electroactive materials may be selected to form lithium ion cells, lithium-sulfur cells, or lithium metal cells, by way of example. In one example, a negative electrode layer includes negative electroactive material in an amount greater than or equal to about 80 weight percent to less than or equal to about 98 weight percent, a first binder in an amount greater than or equal to about 0.5 weight percent to less than or equal to about 10 weight percent, and a first conductive additive in an amount greater than or equal to about 0.5 weight percent to less than or equal to about 10 weight percent. A positive electrode layer comprises a positive electroactive material in an amount greater than or equal to about 80 weight percent to less than or equal to about 98 weight percent, a second binder in an amount greater than or equal to about 0.5 weight percent to less than or equal to about 10 weight percent, and a second conductive additive in an amount greater than or equal to about 0.5 weight percent to less than or equal to about 10 weight percent.

### Electrolyte-Separator Systems

An electrolyte-separator system may generally provide ionic conductivity and electrical insulation between adjacent electrode layers. In one example, an electrolyte-separator system includes a polymeric membrane separator and a distinct electrolyte, such as those described above in conjunction with FIG. 1. The distinct electrolyte may include liquid, gel, and/or solid components. In another example, an electrolyte-separator system includes a solid-state electrolyte, such as those described above in conjunction with FIG. 1.

### Electrically-Conductive Layers

The negative electrode electrically-conductive layers may generally include any of the materials discussed above with respect to the negative electrode current collector 32 of FIG. 1. A negative electrode electrically-conductive layer may include aluminum, copper, stainless steel, or combinations thereof, by way of example. In one example, a negative electrode electrically-conductive layer includes an aluminum foil (e.g., when the corresponding negative electrode layer includes LTO) or a copper foil having a thickness of greater than or equal to about 4 μm to less than or equal to about 25 μm. In another example, the negative electrode electrically-conductive layer includes a stainless steel foil having a thickness of greater than or equal to about 2 μm to less than or equal to about 20 μm.

The positive electrode electrically-conductive layers may generally include any of the materials discussed above with respect to the positive electrode current collectors 34 of FIG. 1. A positive electrode electrically-conductive layer may include aluminum, stainless steel, or a combination of aluminum and stainless steel. In one example, a positive electrode electrically-conductive layer includes al aluminum foil having a thickness of greater than or equal to about 4 μm to less than or equal to about 25 μm. In another example, a positive electrode electrically-conductive layer includes a stainless steel foil having a thickness of greater than or equal to about 2 μm to less than or equal to about 20 μm.

### Distinct Tab Components

In certain aspects, the tab components may be formed from materials such as the materials described in conjunction with the negative and positive electrode current collectors 32, 34 of FIG. 1. A negative tab component may include nickel, copper, aluminum, or combinations thereof. In one example, a negative tab component includes nickel-coated copper or aluminum (e.g., when the corresponding negative electrode layer includes LTO). A positive tab component may include aluminum.

### Electrically-Insulating Housing

An electrically-insulating housing may be formed from any suitable electrically-insulating material. In certain aspects, the electrically-insulating material includes a polyolefin-based polymer, a polyethylene or polypropylene material (e.g., polyethylene-acrylic acid copolymer, chlorinated polypropylene, ethylene-propylene copolymer, polypropylene-acrylic acid copolymer), or combinations thereof, by way of example. In various aspects, the housing may comprise a metal (e.g., aluminum) that is insulated with one or more layers of an electrically-insulating material, such as those described above.

### Seals

In certain aspects, a seal may include a polyolefin-based polymer, a polyethylene or polypropylene material (e.g., polyethylene-acrylic acid copolymer, chlorinated polypropylene, ethylene-propylene copolymer, polypropylene-acrylic acid copolymer), or combinations thereof, by way of example. In various aspects, the seal and the housing may be formed from the same material. A thickness of the seal may be greater than or equal to about 0.05 mm to less than or equal to about 0.3 mm, by way of example.

### Methods of Manufacturing

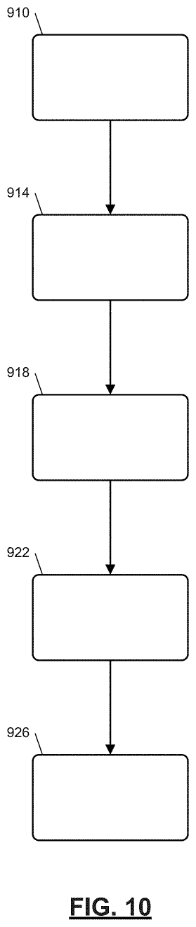

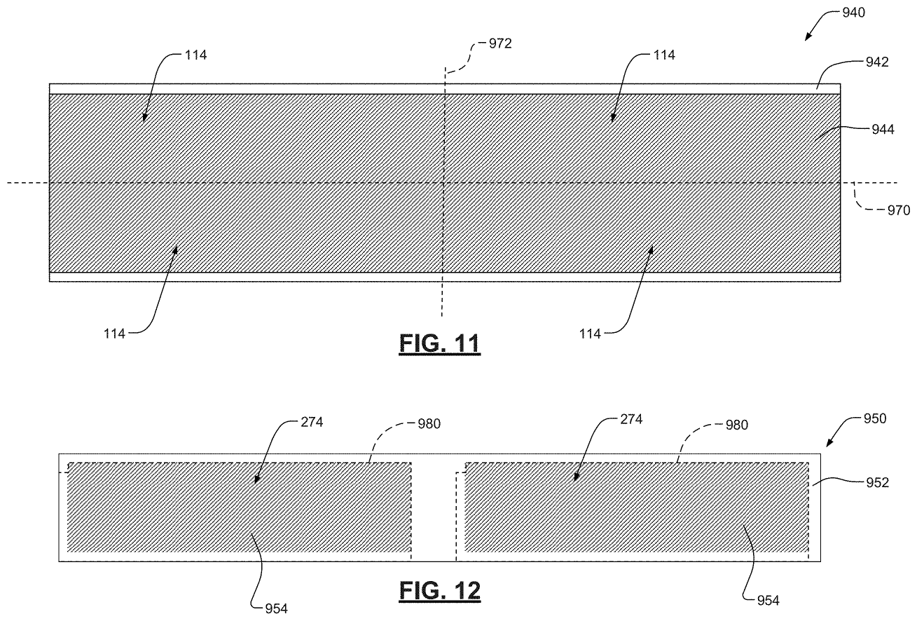

In various aspects, the present disclosure provides a method of manufacturing an electrochemical device. With reference to FIG. 10, the method generally includes forming one or more electrode component precursors at 910, optionally separating electrode component precursors from one another at 914, stacking or winding electrode components with electrolyte-separator systems at 918, forming an electrochemical cell assembly by forming electrical connections between electrochemical cells and tab components at 922, and forming the electrochemical device by sealing the electrochemical cell assembly within a housing at 926.

### Forming Electrode Components or Electrode Component Precursors

Forming an electrode component may include depositing an electrode layer onto an electrically conductive layer. Suitable deposition techniques include slot die coating, comma bar direct coating, comma bar reverse coating, lip coating, gravure printing or coating, electrochemical deposition, chemical vapor deposition, or combinations thereof, by way of example. In certain aspects, an electrode component precursor is formed in a continuous coating operation and subsequently separated into discrete electrode components at step 914. In certain aspects, the method may include forming discrete electrode components and step 914 may be omitted.

In various aspects, the method may include forming electrode component precursors. An electrode component precursor may be formed by continuously or intermittently depositing one or more electrode layers on a sheet or roll of electrically conductive material.

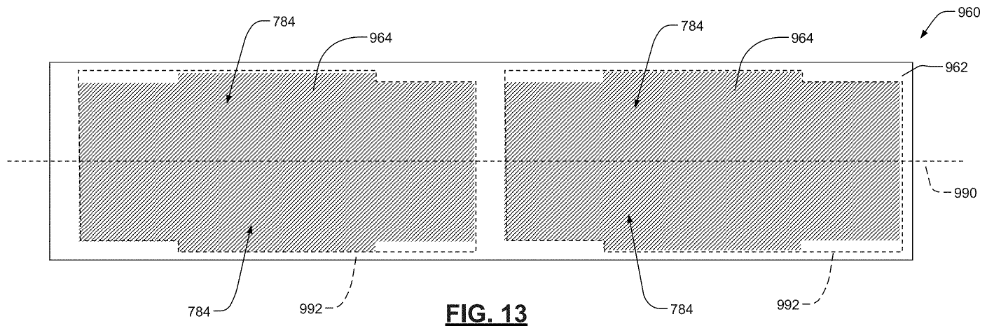

With reference to FIG. 11, an electrode component precursor 940 for the negative electrode component 114 of FIG. 3C according to various aspects of the present disclosure is provided. The electrode component precursor 940 includes an electrically-conductive material sheet 942 and a continuous electrode layer 944. In various aspects, the electrodes of FIGS. 3E and 4B may be formed by similar methods.

Referring to FIG. 12, another electrode component precursor 950 for the negative electrode component 274 of FIG. 5B according to various aspects of the present disclosure is provided. The electrode component precursor 950 includes an electrically-conductive material sheet 952 and intermittent electrode layers 954. In various aspects, the electrodes of FIGS. 5A, 6B, 6D, 7B, 7D, 8B, and 8D may be formed by similar methods.

With reference to FIG. 13, yet another electrode component precursor 960 for the negative electrode component 784 of FIG. 9B according to various aspects of the present disclosure is provided. The electrode component precursor 960 includes an electrically-conductive material sheet 962 and intermittent electrode layers 964. In various aspects, the electrode of FIG. 9D may be formed by a similar method.

### Optionally Separating Electrode Component Precursors

When step 910 includes forming an electrode component precursor instead of an electrode component, the method may include separating individual electrode components from the electrode component precursor. Separating may include a cutting or slitting operation, such as rotary blade slitting, mechanical notching/blanking, laser cutting, or combinations thereof, by way of example.

Returning to FIG. 11, the electrode component precursor 940 may be separated in half longitudinally, in a first boundary 970. The electrode component precursor 940 may be further separated substantially perpendicular to the first boundary 970 to form the negative electrode components 114, as shown by a second boundary 972. The electrode component precursor 940 may be substantially longer so that step 914 includes forming a plurality of second boundaries 972.

Returning to FIG. 12, the electrode component precursor 950 may be separated at a plurality of boundaries 980 to form the negative electrode components 274.

Returning to FIG. 13, the electrode component precursor 960 may be separated longitudinally at a first boundary 990. The electrode component precursor 960 may be further separated at second boundaries 992 to form the negative electrode components 784.

### Stacking or Welding Electrode Component Precursors

At 918, the electrode components may be stacked or wound with electrolyte-separator systems. In one example, the electrode components are alternatingly stacked with polymeric separators disposed therebetween. A liquid or gel electrolyte may be added during step 918, or after step 922, by way of example.

### Forming Electrochemical Cell Assembly

At 922, forming an electrochemical cell assembly generally includes forming electrical connections. Electrical connections are formed between electrochemical cells, when an electrochemical device includes more than one electrochemical cell. Electrical connections are also formed between tab portions of electrically-conductive layers and respective distinct tab components. In certain aspects, forming electrical connections may include welding. Welding may include ultrasonic welding, laser welding, spot welding, or combinations thereof, by way of example.

### Forming Electrochemical Device

At 926, forming an electrochemical device includes sealing the electrochemical cell assembly within an electrochemical housing. Sealing may include heat sealing with or without the application of a predetermined pressure, laser welding, melting, adhesive bonding, or combinations thereof, by way of example. In certain aspects, sealing may further include the application of another material between the electrically-insulating housing and the terminal portions.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrode component comprising:
an electrically-conductive layer comprising a current collector portion and a tab portion; and
an electrode layer disposed on at least a portion of the current collector portion and comprising a first edge, the electrode layer comprising an electroactive material and defining a first dimension substantially parallel to the first edge and a second dimension substantially perpendicular to the first edge, an aspect ratio of the first dimension to the second dimension being greater than or equal to about 2, wherein the tab portion is disposed adjacent to at least a portion of the first edge and an interface between the electrode layer and the tab portion defines an interface length of greater than or equal to about 50% of the first dimension.

2. The electrode component of claim 1, wherein the tab portion is disposed adjacent to substantially the entire first edge.

3. The electrode component of claim 1, wherein the tab portion is disposed adjacent to the first edge and the second edge and the tab portion extends continuously along the first edge and at least a portion of a second edge substantially perpendicular to the first edge.

4. The electrode component of claim 1, further comprising a distinct tab component electrically connected to the tab portion, the tab component being electrically conductive.

5. The electrode component of claim 4, wherein the tab component is L-shaped and is disposed adjacent to substantially the entire first edge.

6. The electrode component of claim 4, wherein the tab component is coupled to the tab portion by a plurality of welds, each weld having an area of greater than or equal to about 30 mm² to less than or equal to about 10,000 mm².

7. The electrode component of claim 4, wherein the tab component comprises an internal portion configured to be disposed inside of a battery housing and a terminal portion configured to be disposed outside of a battery housing, the terminal portion defining a surface area of greater than or equal to about 600 mm² to less than or equal to about 20,000 mm².

8. The electrode component of claim 1, wherein the aspect ratio is greater than or equal to about 5.

9. The electrode component of claim 1, wherein the first dimension is greater than or equal to about 300 mm and the second dimension is less than or equal to about 150 mm.

10. An electrode component comprising:
an electrically-conductive layer comprising a current collector portion and a tab portion defining a first perimeter; and
an electrode layer disposed on at least a portion of the current collector portion, comprising an electroactive material, and defining a second perimeter, the electrode layer defining a first dimension and a second dimension substantially perpendicular to the first dimension, an aspect ratio of the first dimension to the second dimension being greater than or equal to about 2, wherein the second perimeter defines a concave polygon that shares at least two edges with the first perimeter.

11. The electrode component of claim 10, wherein:
the electrode layer comprises a first axis and a second axis, the first axis extending substantially parallel to the first dimension and through a midpoint of the second dimension, the second axis extending substantially parallel to the second dimension and through a midpoint of the first dimension; and
the electrode layer comprises a notch disposed along a concave portion of the second perimeter.

12. The electrode component of claim 11, wherein the electrode layer has (i) reflective symmetry about the first axis, (ii) reflective symmetry about the second axis, or (iii) second order rotational symmetry.

13. The electrode component of claim 11, wherein:
the second perimeter includes the at least two edges, a distinct first edge, and a distinct second edge; and
the first perimeter includes the at least two edges, a distinct third edge extending substantially collinear with the first edge, and a distinct fourth edge extending substantially collinear with the second edge.

14. An electrochemical device comprising:
an electrochemical cell comprising,
a negative electrode component comprising,
a first electrically-conductive layer comprising a first current collector portion and a first tab portion, and
a negative electrode layer disposed on at least a portion of the first current collector portion and comprising a first edge, the negative electrode layer comprising a negative electroactive material and defining a first dimension substantially parallel to the first edge and a second dimension substantially perpendicular to the first edge, a first aspect ratio of the first dimension to the second dimension being greater than or equal to about 2, wherein the first tab portion is disposed adjacent to at least a portion of the first edge and a first interface between the negative electrode layer and the first tab portion defines a first interface length of greater than or equal to about 50% of the first dimension;
a positive electrode component comprising,
a second electrically-conductive layer comprising a second current collector portion and a second tab portion, and
a positive electrode layer disposed on at least a portion of the second current collector portion and comprising a second edge, the positive electrode layer comprising a positive electroactive material and defining a third dimension substantially parallel to the second edge and a fourth dimension substantially perpendicular to the second edge, a second aspect ratio of the third dimension to the fourth dimension being greater than or equal to about 2, wherein the second tab portion is disposed adjacent to at least a portion of the second edge and a second interface between the positive electrode layer and the second tab portion defines a second interface length of greater than or equal to about 50% of the first dimension, and
an electrolyte-separator system disposed between the positive electrode layer and the negative electrode layer, the electrode-separator system being ionically conductive and electrically insulating.

15. The electrochemical device of claim 14, wherein:
the negative electrode component further comprises a first distinct tab component electrically connected to the first tab portion, the first tab component comprising a first terminal portion configured to be disposed outside of a housing of the electrochemical device; and
the positive electrode component further comprises a second distinct tab component electrically connected to the second tab portion, the second tab component comprising a second terminal portion configured to be disposed outside of the housing, wherein the first terminal portion and the second terminal portion are disposed on a common side of the electrochemical device.

16. The electrochemical device of claim 15, wherein the first terminal portion and the second terminal portion each have surface areas of greater than or equal to about 600 mm² to less than or equal to about 20,000 mm².

17. The electrochemical device of claim 15, wherein:
the first electrically-conductive layer comprises a first electrically-conductive material selected from the group consisting of aluminum, copper, stainless steel, or combinations thereof;
the second electrically-conductive layer comprises a second electrically-conductive material selected from the group consisting of aluminum, stainless steel, or a combination thereof;
the first tab component comprises a third electrically-conductive material selected from the group consisting of nickel, copper, aluminum, or combinations thereof; and
the second tab component comprises a fourth electrically-conductive material comprising aluminum.

18. The electrochemical device of claim 15, wherein the electrochemical cell comprises a first electrochemical cell and a second electrochemical cell, and the first electrochemical cell is electrically connected to the second electrochemical cell by a plurality of welds.

19. The electrochemical device of claim 18, wherein each weld of the plurality of welds has an area of greater than or equal to about 30 mm² to less than or equal to about 10,000 mm².

20. The electrochemical device of claim 15, wherein:
the negative electrode layer comprises the negative electroactive material in an amount greater than or equal to about 80 weight percent to less than or equal to about 98 weight percent, a first binder in an amount greater than or equal to about 0.5 weight percent to less than or equal to about 10 weight percent, and a first conductive additive in an amount greater than or equal to about 0.5 weight percent to less than or equal to about 10 weight percent; and
the positive electrode layer comprises the positive electroactive material in an amount greater than or equal to about 80 weight percent to less than or equal to about 98 weight percent, a second binder in an amount greater than or equal to about 0.5 weight percent to less than or equal to about 10 weight percent, and a second conductive additive in an amount greater than or equal to about 0.5 weight percent to less than or equal to about 10 weight percent.
